(19) United States
(12) Patent Application Publication
(10) Pub. No.: US 2026/0066649 A1
(43) Pub. Date: Mar. 5, 2026

(54) POWER SUPPLY UNIT, POWER SUPPLY NETWORK, AND OPERATION METHODS THEREOF

(71) Applicant: SHENZHEN MEGMEET ELECTRICAL CO., LTD., Shenzhen (CN)

(72) Inventors: Qing ZHANG, San Jose, CA (US); Yun GAO, San Jose, CA (US)

(73) Assignee: SHENZHEN MEGMEET ELECTRICAL CO., LTD., Shenzhen (CN)

(21) Appl. No.: 18/820,262

(22) Filed: Aug. 30, 2024

(51) Int. Cl. H02J 1/10; H02M 3/156

(52) U.S. Cl. CPC H02J 1/102; H02J 1/106; H02M 3/156

(57) ABSTRACT

In certain aspects, a power supply unit includes a direct current (DC) power supply circuit and a regulation control circuit coupled to the DC power supply circuit. The DC power supply circuit is configured to provide an output voltage and an output current at an output port. The regulation control circuit is configured to generate a regulation control signal based at least in part on a measured voltage value of the output voltage and a measured current value of the output current at the output port. The DC power supply circuit is further configured to, based on the regulation control signal, regulate at least one of the output voltage to have a target voltage value or the output current to have a target current value.

### BACKGROUND

The present disclosure relates to power supply units, power supply networks, and operation methods thereof.

A power supply unit is an important part of an electric circuit as it provides power to the circuit for a proper operation. Many electronic devices require a constant voltage without any fluctuations. A power supply unit may take an unregulated power and convert it into a stable, regulated power. A Switching Mode Power Supply (SMPS) unit is a type of power supply unit that uses a switching device to transfer electrical energy from a source to a load. Usually, the source is either an alternating current (AC) source or a direct current (DC) source, and the load is either an AC load or a DC load. The SMPS unit has become a standard type of power supply unit for electronic devices because of its high efficiency, low cost, and high power density.

### SUMMARY

In one aspect, a power supply unit includes a direct current (DC) power supply circuit and a regulation control circuit coupled to the DC power supply circuit. The DC power supply circuit is configured to provide an output voltage and an output current at an output port. The regulation control circuit is configured to generate a regulation control signal based at least in part on a measured voltage value of the output voltage and a measured current value of the output current at the output port. The DC power supply circuit is further configured to, based on the regulation control signal, regulate at least one of the output voltage to have a target voltage value or the output current to have a target current value.

In some implementations, the regulation control circuit includes a controller coupled to the DC power supply circuit and a modulator coupled to the controller and the DC power supply circuit. The controller is configured to determine a difference signal based on a virtual impedance of a virtual power source equivalent model, a voltage difference between the measured voltage value and a reference voltage value, and a current difference between the measured current value and a reference current value. The controller is configured to generate a modulation reference signal based on the difference signal. The modulator is configured to generate the regulation control signal based on the modulation reference signal.

In some implementations, the difference signal is expressed as follows:

$$d ( s ) = \frac{\vert {Z}_{v} \vert}{( \vert {Z}_{v} \vert + 1 )} \frac{( {V}_{s} - {V}_{o}^{′} )}{( {R}_{v} + s {L}_{v} )} + \frac{\vert {Z}_{v} \vert}{( \vert {Z}_{v} \vert + 1 )} ( {I}_{s} - {I}_{o}^{′} ) ,$$

where d(s) represents the difference signal, Zᵥ represents the virtual impedance including a resistance Rᵥ and an inductance Lᵥ, Vₛ represents the reference voltage value,

$${V}_{o}^{′}$$

represents the measured voltage value, Iₛ represents the reference current value, and

$${I}_{o}^{′}$$

represents the measured current value.

In some implementations, the power supply unit is equivalent to the virtual power source equivalent model. The virtual power source equivalent model includes a DC Thévenin equivalent model, which includes an equivalent voltage source and the virtual impedance in series connection with the equivalent voltage source. The virtual power source equivalent model further includes a DC current source in parallel connection with the DC Thévenin equivalent model. The equivalent voltage source has the reference voltage value, and the DC current source has the reference current value.

In some implementations, the regulation control circuit further includes a reference setting circuit coupled to the controller, and configured to set the reference voltage value and the reference current value.

In some implementations, the regulation control circuit further includes an impedance setting circuit coupled to the controller, and configured to set a resistance value and an inductance value of the virtual impedance.

In some implementations, the DC power supply circuit includes a DC power source configured to output a power supply signal, a DC to DC converter configured to convert the power supply signal received from the DC power source to a converted power supply signal, and an output network including the output port and configured to output the output voltage and the output current at the output port based on the converted power supply signal.

In another aspect, a power supply network includes a first power supply unit and a second power supply unit in parallel connection with the first power supply unit. The first power supply unit includes a first DC power supply circuit including a first output port. The first DC power supply circuit is configured to provide an output voltage and a first output current at the first output port. The first power supply unit further includes a first regulation control circuit coupled to the first DC power supply circuit. The first regulation control circuit is configured to generate a first regulation control signal based at least in part on a first measured voltage value of the output voltage and a first measured current value of the first output current at the first output port. The first DC power supply circuit is further configured to regulate, based on the first regulation control signal, the output voltage to have a target voltage value and the first output current to have a first target current value at the first output port. The second power supply unit includes a second DC power supply circuit and a second regulation control circuit coupled to the second DC power supply circuit. The second DC power supply circuit includes a second output port in parallel connection with the first output port, and is configured to provide the output voltage and a second output current at the second output port. The second regulation control circuit is configured to generate a second regulation control signal based at least in part on a second measured voltage value of the output voltage and a second measured current value of the second output current at the second output port. The second DC power supply circuit is further configured to regulate, based on the second regulation control signal, the output voltage to have the target voltage value and the second output current to have a second target current value at the second output port.

In some implementations, the first regulation control circuit includes a first controller coupled to the first DC power supply circuit and a first modulator coupled to the first controller and the first DC power supply circuit. The first controller is configured to determine a first difference signal based on a first virtual impedance of a first virtual power source equivalent model, a first voltage difference between the first measured voltage value of the output voltage and a reference voltage value, and a first current difference between the first measured current value of the first output current and a first reference current value. The first controller is configured to generate a first modulation reference signal based on the first difference signal. The first modulator is configured to generate the first regulation control signal based on the first modulation reference signal.

In some implementations, the first difference signal is expressed as follows:

$$d ( s ) = \frac{\vert {Z}_{v} \vert}{( \vert {Z}_{v} \vert + 1 )} \frac{( {V}_{s} - {V}_{o}^{′} )}{( {R}_{v} + s {L}_{v} )} + \frac{\vert {Z}_{v} \vert}{( \vert {Z}_{v} \vert + 1 )} ( {I}_{s} - {I}_{o}^{′} ) ,$$

where d(s) represents the first difference signal, Zᵥ represents the first virtual impedance including a resistance Rᵥ and an inductance Lᵥ, Vₛ represents the reference voltage value,

$${V}_{o}^{′}$$

represents the first measured voltage value of the output voltage, Iₛ represents the first reference current value, and

$${I}_{o}^{′}$$

represents the first measured current value of the first output current.

In some implementations, the second regulation control circuit includes a second controller coupled to the second DC power supply circuit and a second modulator coupled to the second controller and the second DC power supply circuit. The second controller is configured to determine a second difference signal based on a second virtual impedance of a second virtual power source equivalent model, a second voltage difference between the second measured voltage value of the output voltage and the reference voltage value, and a second current difference between the second measured current value of the second output current and a second reference current value. The second controller is configured to generate a second modulation reference signal based on the second difference signal. The second modulator is configured to generate the second regulation control signal based on the second modulation reference signal.

In some implementations, the first target current value of the first power supply unit is equal to the second target current value of the second power supply unit.

In some implementations, the first power supply unit is equivalent to the first virtual power source equivalent model. The second power supply unit is equivalent to the second virtual power source equivalent model which is identical to the first virtual power source equivalent model. The first virtual impedance is identical to the second virtual impedance. Each of the first and second virtual power source equivalent models includes: a DC Thévenin equivalent model including an equivalent voltage source and the first or second virtual impedance in series connection with the equivalent voltage source; and a DC current source in parallel connection with the DC Thévenin equivalent model. The equivalent voltage source has the reference voltage value, and the DC current source has the first or second reference current value.

In some implementations, the first target current value of the first power supply unit is equal to the second target current value of the second power supply unit multiplied by a proportional current sharing coefficient.

In some implementations, the proportional current sharing coefficient includes a ratio between a first rated capacity of the first power supply unit and a second rated capacity of the second power supply unit.

In some implementations, the first power supply unit is equivalent to the first virtual power source equivalent model. The second power supply unit is equivalent to the second virtual power source equivalent model. The first virtual power source equivalent model includes: a first DC Thévenin equivalent model including a first equivalent voltage source and the first virtual impedance in series connection with the first equivalent voltage source; and a first DC current source in parallel connection with the first DC Thévenin equivalent model. The second virtual power source equivalent model includes: a second DC Thévenin equivalent model including a second equivalent voltage source and the second virtual impedance in series connection with the second equivalent voltage source; and a second DC current source in parallel connection with the second DC Thévenin equivalent model. Each of the first and second equivalent voltage sources has the reference voltage value, the first DC current source has the first reference current value, and the second DC current source has the second reference current value.

In some implementations, the first regulation control circuit further includes a first reference setting circuit coupled to the first controller and configured to set the reference voltage value and the first reference current value. The first regulation control circuit further includes a first impedance setting circuit coupled to the first controller and configured to set a resistance value and an inductance value of the first virtual impedance. The second regulation control circuit further includes a second reference setting circuit coupled to the second controller and configured to set the second reference current value based on the proportional current sharing coefficient and the first reference current value. The second regulation control circuit further includes a second impedance setting circuit coupled to the second controller and configured to set a resistance value and an inductance value of the second virtual impedance based on the proportional current sharing coefficient and the first virtual impedance.

In still another aspect, a method of operating a power supply unit including a DC power supply circuit and a regulation control circuit is disclosed. The method includes providing, by the DC power supply circuit, an output voltage and an output current at an output port. The method further includes generating, by the regulation control circuit, a regulation control signal based at least in part on a measured voltage value of the output voltage and a measured current value of the output current at the output port. The method additionally includes regulating, by the DC power supply circuit and based on the regulation control signal, the output voltage to have a target voltage value and the output current to have a target current value.

In some implementations, generating the regulation control signal includes: determining a difference signal based on a virtual impedance of a virtual power source equivalent model, a voltage difference between the measured voltage value of the output voltage and a reference voltage value, and a current difference between the measured current value of the output current and a reference current value; generating a modulation reference signal based on the difference signal; and generating the regulation control signal based on the modulation reference signal.

In some implementations, the power supply unit is equivalent to the virtual power source equivalent model. The virtual power source equivalent model includes: a DC Thévenin equivalent model including an equivalent voltage source and the virtual impedance in series connection with the equivalent voltage source; and a DC current source in parallel connection with the DC Thévenin equivalent model. The equivalent voltage source has the reference voltage value, and the DC current source has the reference current value.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

FIG. 1 illustrates a block diagram of DC SMPS units that are connected in parallel, according to some examples of the present disclosure.

FIG. 2A illustrates exemplary output characteristics of two SMPS units that are connected in parallel without utilizing a current sharing loop, according to some aspects of the present disclosure.

FIG. 2B illustrates exemplary output characteristics of two SMPS units that are connected in parallel when equal current sharing control is achieved, according to some aspects of the present disclosure.

FIG. 3A illustrates a circuit diagram of a power supply circuit in a SMPS unit, according to some aspects of the present disclosure.

FIG. 3B illustrates a diagram of a virtual power source equivalent model corresponding to the SMPS unit of FIG. 3A, according to some aspects of the present disclosure.

FIG. 4A illustrates a block diagram of a power supply unit, according to some aspects of the present disclosure.

FIG. 4B illustrates a circuit diagram of a power supply unit, according to some aspects of the present disclosure.

FIG. 5 illustrates a block diagram of a power supply network, according to some aspects of the present disclosure.

FIG. 6 illustrates a circuit diagram of a power supply network with equal current sharing among parallel-connected power supply units, according to some aspects of the present disclosure.

FIG. 7 illustrates a diagram of virtual power source equivalent models corresponding to the power supply network of FIG. 6, according to some aspects of the present disclosure.

FIG. 8 illustrates a diagram of virtual power source equivalent models corresponding to a power supply network with proportional current sharing among parallel-connected power supply units, according to some aspects of the present disclosure.

FIG. 9 illustrates a circuit diagram of a power supply network with proportional current sharing among parallel-connected power supply units, according to some aspects of the present disclosure.

FIG. 10 illustrates exemplary output characteristics of the virtual power source equivalent models of FIG. 8, according to some aspects of the present disclosure.

FIG. 11 illustrates a flowchart of a method for operating a power supply unit, according to some aspects of the present disclosure.

FIGS. 12A-12E illustrate simulation results of various power supply networks, according to some aspects of the present disclosure.

FIGS. 13A-13D illustrate various applications of a power supply network, according to some aspects of the present disclosure.

The present disclosure will be described with reference to the accompanying drawings.

### DETAILED DESCRIPTION

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In practice, various approaches with varying degrees of complexity and current-sharing performance have been proposed for parallel-connected SMPS units. In general, methods for connecting SMPS units in parallel are characterized by connection styles, control configurations, and feedback functions, where each SMPS unit may include a DC to DC converter (DC/DC converter). As a power source can be either a voltage source or a current source, there are three fundamental structures (e.g., three types of structures) for connecting the SMPS units in parallel. Specifically, in a first type (Type 1), all SMPS units are voltage (Thévevin) sources. In a second type (Type 2), one or more SMPS units are voltage (Thévenin) sources, and other SMPS units are current (Norton) sources. In a third type (Type 3), all SMPS units are current (Norton) sources.

Some issues exist in the above three types of structures in terms of current-sharing accuracy, voltage regulation, dynamic performance, or other consideration factors. For example, Type 1 may have inaccurate current-sharing performance, poor dynamic response and suboptimal performance for large load ranges (low gain required for stability across a wide load range). Besides, Type 1 may lack robustness to variations in the current-sharing gain, and may have poor voltage regulation due to reliance on a large output resistance for the current sharing. In another example, with respect to Type 2, a precise current sensor and a current divider are needed on the load side. Accuracy in the current sharing is affected by variations in the master's current, resulting in poor noise immunity. Modularity is limited in Type 2 because the current divider is used on the load side. In still another example, with respect to Type 3, the accuracy of the current sharing depends greatly on the precise selection of current loop parameters. The control structure of Type 3 is complicated. Modularity is limited due to the requirement of interconnected current-sharing loops.

Further, some existing virtual impedance-based droop control methods for parallel-connected SMPS units may have the following issues. For example, with respect to complexity, implementations of the existing droop control methods can be complex, especially when dealing with high-order harmonics or unbalanced loads. In another example, with respect to sensitivity, the existing droop control methods are sensitive to the bandwidth of the current/voltage control loops, thereby limiting their effectiveness. In still another example, with respect to noise amplification, derivative controllers involved in the existing droop control methods can amplify the measurement noise, thereby requiring additional filters or methods to reduce or eliminate the measurement noise.

To address one or more of the aforementioned issues, the present disclosure introduces a virtual-model based control scheme for a power supply network which includes parallel-connected power supply units. The control scheme disclosed herein is based on a virtual power source equivalent model, and is a simple and efficient control scheme that can ensure equal current sharing among the parallel-connected power supply units (e.g., output currents of the power supply units being equal to one another) or proportional current sharing among the power supply units (e.g., output currents of the power supply units satisfying a proportional current sharing condition determined by a proportional current sharing coefficient, as described below in more detail). By emulating the virtual power source equivalent model, the control scheme disclosed herein can achieve droop control, which facilitates precise current sharing (e.g., equal or proportional current sharing) among the parallel-connected power supply units without the need of communicating signals between the power supply units. In the control scheme disclosed herein, the modularity and dynamic response of the power supply units can be enhanced, and stability of the power supply units across varying load ranges can also be enhanced, regardless of the type, capacity, topology, modulation, etc., of the power supply units. The control scheme disclosed herein can be easily implemented using digital circuits (e.g., a microcontroller (MCU) or digital signal processor (DSP)) or analog circuits (e.g., operational amplifiers, transistors, resistors, capacitors, etc.).

For example, the control scheme disclosed herein involves creating and emulating a one-port virtual power source equivalent model to control a DC power supply of a real power supply unit (e.g., an SMPS unit). The virtual power source equivalent model includes a DC Thévenin equivalent model in parallel connection with a DC current source. The DC Thévenin equivalent may include a desired DC voltage source Vₛ in series connection with a virtual impedance which has a finite resistance Ry and a finite inductance Ly. The DC current source maintains a constant offset current value Is.

At least a purpose of the control scheme disclosed herein is to mimic the behavior of the virtual power source equivalent model by measuring and regulating an output voltage and an output current of the real power supply unit. The emulation of the finite virtual impedance is achieved using a composite voltage-current controller. Instead of having a primary voltage control loop within a secondary current control loop (or vice versa), both the output voltage and the output current are simultaneously controlled by a single variable (e.g., a difference signal described below) to emulate the virtual impedance in the control scheme disclosed herein. Furthermore, by emulating a voltage source with a complex finite output impedance, voltage droop control can be achieved with a desirable dynamic performance. Consequently, when multiple power supply units each incorporating this control scheme are connected in parallel, identical or proportional current sharing is ensured among the power supply units by appropriately configuring virtual model parameters (e.g., Vₛ, Rᵥ, and Iₛ) of the virtual power source equivalent models corresponding to the power supply units, respectively.

Consistent with some aspects of the present disclosure, the achievement of droop control may not only indicate that the output voltages of the parallel-connected power supply units are the same, but also indicate that the output currents of the parallel-connected power supply units satisfy a current sharing condition. For example, the output currents are equal to one another when equal current sharing is implemented, or the output currents satisfy a proportional current sharing condition determined based on a proportional current sharing coefficient, as described below in more detail.

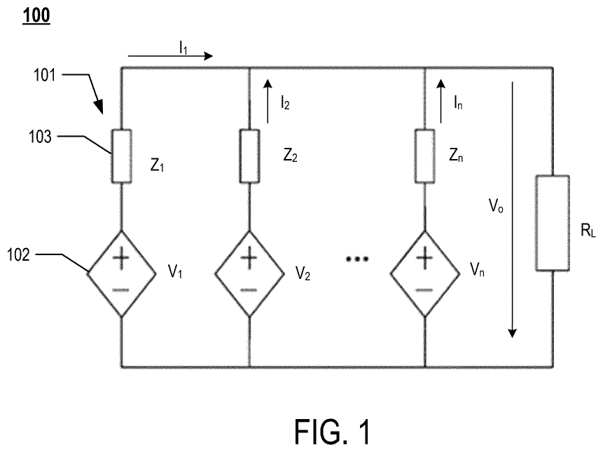

FIG. 1 illustrates a block diagram of DC SMPS units that are connected in parallel, according to some examples of the present disclosure. In some examples, a DC SMPS unit may include a converter and can be equivalent to a Thévenin source (i.e., a dependent voltage source) with an output impedance. Multiple DC SMPS units may be connected to a load resistance (R_{L}) in parallel, and an equivalent structure 100 of the parallel-connected DC SMPS units is shown in FIG. 1. In FIG. 1, each DC SMPS unit can be considered as a branch 101, which includes a Thévenin source 102 and an output impedance 103. When connecting the multiple DC SMPS units in parallel without any active current-sharing control loop, each branch may need to be embedded with a respective droop control scheme to provide current sharing among the multiple DC SMPS units. Specifically, in the absence of an active current-sharing loop, each DC SMPS unit (each branch) may have a finite output resistance at a steady state.

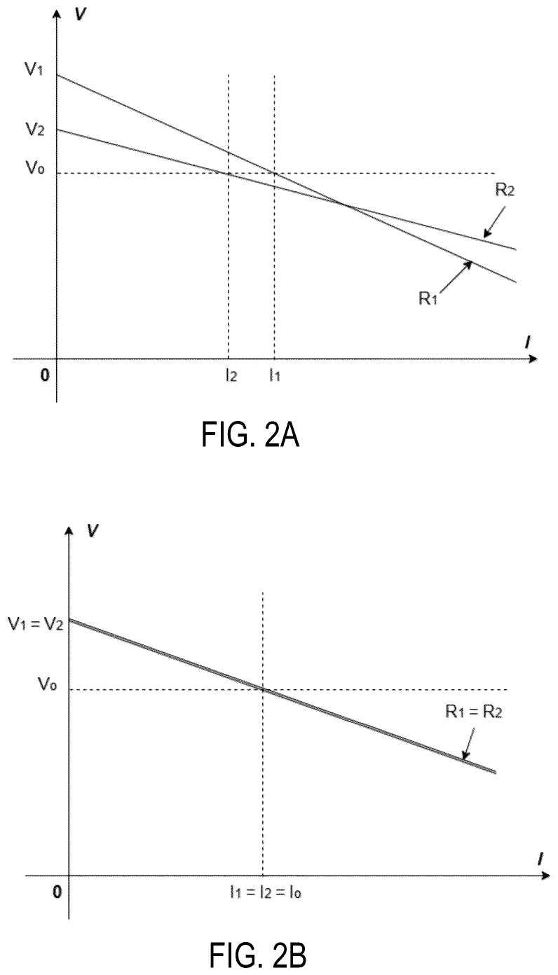

Let Iᵢ, Vᵢ, and Rᵢ represent an output current, an equivalent Thévenin voltage, and an output resistance of the i^{th} DC SMPS unit (branch i), respectively. A common output voltage of each DC SMPS unit is denoted as Vₒ. FIG. 2A illustrates output characteristics of two DC SMPS units (e.g., a first branch “branch 1” and a second branch “branch 2”) connected in parallel without utilizing a current sharing loop. As shown in FIG. 2A, output curves of the two DC SMPS units are different (e.g., the output curves intersect with each other and are not identical). When the common output voltage of the first and second branches is Vₒ, the first branch may have a current I₁, and the second branch may have a current I₂. A current sharing error between the first branch and the second branch (e.g., a current difference between the first and second DC SMPS units) can be expressed as follows:

$$Δ I = {I}_{1} - {I}_{2} = \frac{{R}_{2} {V}_{1} - {R}_{1} {V}_{2} + 2 ( {V}_{1} - {V}_{2} ) {R}_{L}}{{R}_{1} {R}_{2} + {R}_{1} {R}_{L} + {R}_{2} {R}_{L}} . \qquad ( 1 )$$

In the above equation (1), R_{L} represents a load resistance. When equal (or identical) current sharing control is achieved between the first branch and the second branch, the current sharing error ΔI in the above equation (1) becomes zero, which can occur only if V₁=V₂ and R₁=R₂. Therefore, in practice, equal current sharing can be accomplished among the parallel-connected DC SMPS units by setting all Vᵢ to be identical and all Rᵢ to be identical. FIG. 2B illustrates output characteristics of the two DC SMPS units of FIG. 2A when equal current sharing control is achieved. As shown in FIG. 2B, when V₁=V₂ and R₁=R₂, the output curves of the two DC SMPS units are identical (e.g., the output curves are completely overlapped with each other). When the common output voltage of the first and second branches is Vₒ, the first branch and the second branch may have the same output current Iₒ=I₁=I₂.

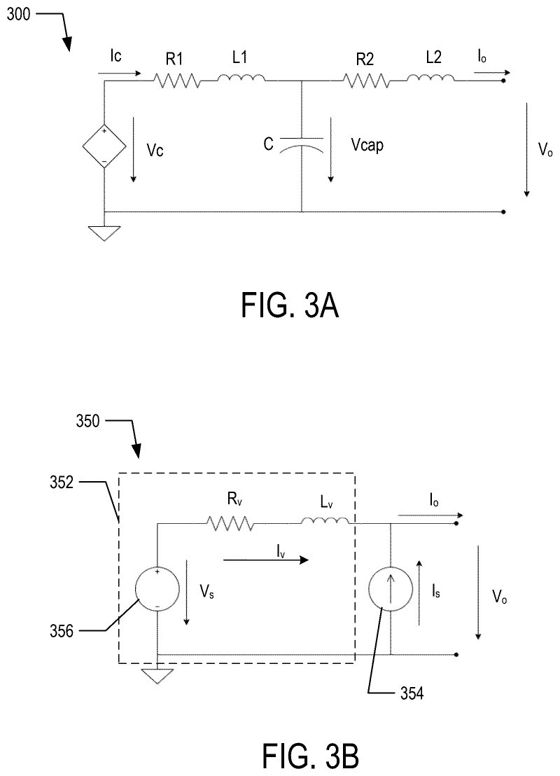

Therefore, according to the one-port network theory, if each parallel-connected DC SMPS unit is contrived to behave as the same virtual Thévenin equivalent, it is easy to keep all Vᵢ to be identical and all Rᵢ to be identical. Then, droop control and equal current sharing are achieved among the parallel-connected DC SMPS units. Furthermore, to improve the performance of the virtual Thévenin equivalent, an offset DC current source is added to the Thévenin equivalent in parallel to offset the output voltage droop caused by the virtual impedance. For instance, with reference to FIG. 3B shown below, if only the Thévenin equivalent is used without an offset DC current source, the output voltage Vₒ may drop below Vₛ when the output current Iₒ flows through a virtual impedance Rᵥ, i.e., Vₒ=Vₛ−Rᵥ*Iₒ. However, if an offset DC current source Iₛ is added in parallel and Iₛ=Iₒ coincidently, in this case the output voltage Vₒ becomes Vₒ=Vₛ−Rᵥd*(Iₒ−Iₛ)=Vₛ.

Consistent with some aspects of the present disclosure, a virtual power source equivalent model is included in the control scheme disclosed herein to facilitate droop control and current sharing among the parallel-connected DC SMPS units. FIG. 3A illustrates a circuit diagram of a power supply circuit 300 in a power supply unit, according to some aspects of the present disclosure. FIG. 3A only shows an exemplary circuit structure of power supply circuit 300. It is contemplated that power supply circuit 300 may have a circuit structure different from that shown in FIG. 3A, which is not limited herein. FIG. 3B illustrates a diagram of a virtual power source equivalent model 350 which is equivalent to the power supply unit of FIG. 3A, according to some aspects of the present disclosure. Virtual power source equivalent model 350 provides an output voltage Vₒ and an output current Iₒ at its output port. The power supply unit of FIG. 3A is equivalent to virtual power source equivalent model 350 such that power supply circuit 300 also provides the output voltage Vₒ and the output current Iₒ at its output port like that of virtual power source equivalent model 350. In other words, the power supply unit of FIG. 3A is configured to mimic the behavior of virtual power source equivalent model 350 to output the same output voltage Vₒ and the same output current Iₒ as virtual power source equivalent model 350.

As shown in FIG. 3B, virtual power source equivalent model 350 may include a DC Thévenin equivalent model 352 and a DC current source 354 in parallel connection with DC Thévenin equivalent model 352. DC Thévenin equivalent model 352 may include an equivalent voltage source 356 and a virtual impedance Zᵥ in series connection with equivalent voltage source 356. Equivalent voltage source 356 may have a reference voltage value Vₛ, and DC current source 354 may have a reference current value Is. The virtual impedance Zᵥ may have a resistance Ry and an inductance Lᵥ, e.g., Zᵥ=Rᵥ+jωLᵥ.

In some implementations, virtual power source equivalent model 350 can be a generalized power source, i.e., a combined voltage-current source model. The virtual impedance Zᵥ is equivalent to a series impedance of equivalent voltage source 356. Lᵥ can be used to remove noise and improve the dynamic response performance of the control scheme disclosed herein. A value of the virtual impedance may be selected as actually needed. For example, as described below in more detail, a zero virtual impedance may cause a virtual model emulator for virtual power source equivalent model 350 to be a pure DC voltage source; an infinite virtual impedance may cause the virtual model emulator to be a pure DC current source; and any non-zero finite virtual impedance may cause the virtual model emulator to be a composite voltage-current source which can be employed for droop control. Unlike a real impedance, this virtual impedance introduces no real power losses, which allows for the emulation of resistive behavior without compromising efficiency.

Referring to FIG. 2B again, when V₁=V₂ and R₁=R₂ are satisfied for the first and second branches discussed above, the following equations (2)-(3) can be obtained when each of the first and second branches is equivalent to the same virtual power source equivalent model 350 of FIG. 3B:

$${V}_{1} = {V}_{2} = {V}_{s} + {I}_{s} {R}_{v} , \qquad ( 2 )$$

$${R}_{1} = {R}_{2} = {R}_{v} . \qquad ( 3 )$$

In other words, as long as each of the paralleled-connected SMPS units is implemented to emulate the same virtual power source equivalent model 350, the conditions for equal current sharing are satisfied (e.g., all Vᵢ are identical and all Rᵢ are identical). As a result, all the parallel-connected SMPS units may provide the same output current Iₒ and the same output voltage Vₒ.

The principle and method of implementing virtual power source equivalent model 350 in an individual SMPS unit are explained herein. Specifically, the reference voltage value Vₛ of equivalent voltage source 356 is set to be a constant, i.e., equal to a nominal output voltage value. The nominal output voltage value can be configured by a user or determined based on actual need. According to the Kirchhoff's current law, a current Iv that flows through the virtual impedance Zᵥ satisfies the following equation (4):

$${I}_{v} = \frac{{V}_{s} - {V}_{o}}{{R}_{v} + s {L}_{v}} = {I}_{o} - {I}_{s} . \qquad ( 4 )$$

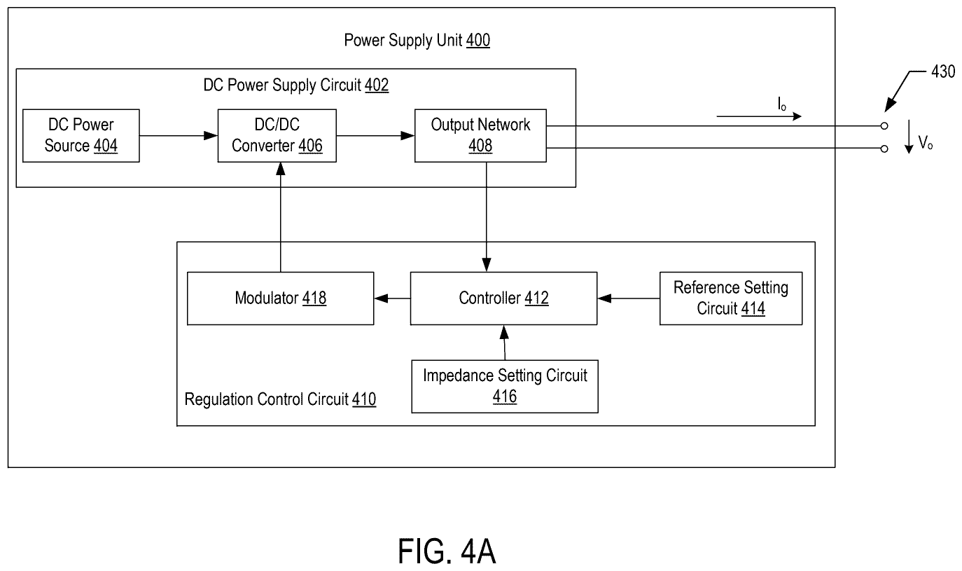

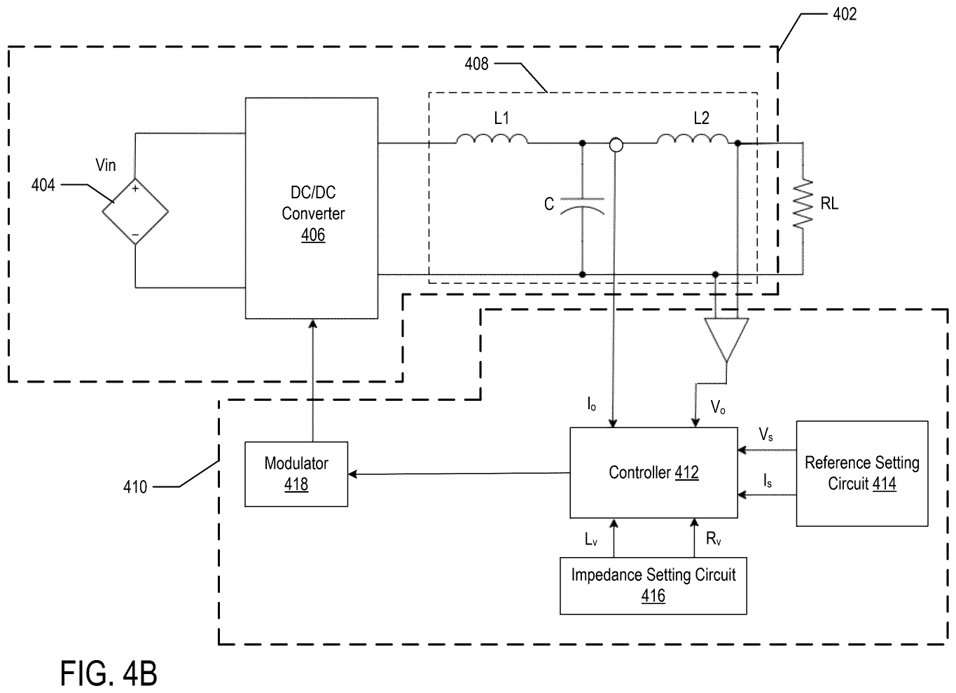

The implementation of emulating virtual power source equivalent model 350 in a real SMPS unit can be obtained using a controller (also referred to as a virtual model emulator) in which both the output current and the output voltage are combined to form a single control variable (e.g., a difference signal, which can be used to regulate both the output voltage and the output current simultaneously as described below in more detail). The controller may emulate the virtual impedance in the above equation (4). The controller is described below in more detail with reference to FIGS. 4A and 4B. For example, virtual power source equivalent model 350 is incorporated into the control scheme disclosed herein using the following transfer function:

$$d ( s ) = \frac{\vert {Z}_{v} \vert}{( \vert {Z}_{v} \vert + 1 )} \frac{( {V}_{s} - {V}_{o} )}{( {R}_{v} + s {L}_{v} )} + \frac{\vert {Z}_{v} \vert}{( \vert {Z}_{v} \vert + 1 )} ( {I}_{s} - {I}_{o} ) . \qquad ( 5 )$$

In the above equation (5), d(s) represents a difference signal, Zᵥ represents the virtual impedance which includes a resistance Rᵥ and an inductance Lᵥ. |Zᵥ| represents a modulus of Zᵥ. Vₛ and Iₛ represent the reference voltage value and the reference current value of virtual power source equivalent model 350, respectively. Vₒ and Iₒ represent the output voltage Vₒ and the output current Iₒ, respectively. An objective of the controller (or the virtual model emulator) is to regulate the output current Iₒ and the output voltage Vₒ to maintain d(s)=0. When the condition d(s)=0 is met, the above equation (4) is satisfied, and virtual power source equivalent model 350 is physically implemented in the real SMPS unit with the incorporation of the virtual impedance Zᵥ.

In the above transfer function (5),

$$\frac{( {V}_{s} - {V}_{o} )}{( {R}_{v} + s {L}_{v} )}$$

and Iₛ−Iₒ are scaled by a normalization factor

$$\frac{\vert {Z}_{v} \vert}{( \vert {Z}_{v} \vert + 1 )} ,$$

which allows the virtual impedance Zᵥ to have any value from zero to infinity. For example, a zero virtual impedance may cause the controller (or the virtual model emulator) to be a voltage controller, whereas an infinite virtual impedance may cause the controller (or the virtual model emulator) to be a current controller. Any finite non-zero virtual impedance may cause the controller (or the virtual model emulator) to be a composite voltage-current controller. Therefore, the controller (or the virtual model emulator) can be generalized into a unified voltage-current controller.

FIG. 4A illustrates a block diagram of a power supply unit 400, according to some aspects of the present disclosure. FIG. 4B illustrates a circuit diagram of power supply unit 400 of FIG. 4A, according to some aspects of the present disclosure. FIGS. 4A and 4B are described together. Referring to FIG. 4A, power supply unit 400 may be a DC SMPS unit, and may include a DC power supply circuit 402 and a regulation control circuit 410. DC power supply circuit 402 may provide an output voltage Vₒ and an output current Iₒ at an output port 430. Regulation control circuit 410 may be coupled to DC power supply circuit 402, and may generate a regulation control signal based at least in part on a measured voltage value of the output voltage Vₒ and a measured current value of the output current Iₒ at output port 430. Then, DC power supply circuit 402 may regulate, based on the regulation control signal, at least one of the output voltage Vₒ to have a target voltage value or the output current Iₒ to have a target current value.

In some implementations, the target voltage value of the output voltage Vₒ can be a nominal voltage value set by a user or determined based on actual need. The target voltage value can be a voltage value that DC power supply circuit 402 aims to provide at output port 430. For example, by regulating the output voltage Vₒ based on the regulation control signal, the measured voltage value of the output voltage Vₒ at output port 430 may converge to the target voltage value and be stabilized at the target voltage value. As described below in more detail, when multiple power supply units 400 are connected in parallel, the output voltage Vₒ of each power supply unit 400 may have the same target voltage value. That is, each power supply unit 400 provides the output voltage Vₒ having the same target voltage value at its output port.

In some implementations, the target current value of the output current Iₒ can be a current value that satisfies a current sharing condition (e.g., an equal current sharing condition or a proportional current sharing condition). For example, when multiple power supply units 400 are connected in parallel, the target current value of the output current Iₒ of each power supply unit 400 is identical such that the equal current sharing condition is satisfied. Alternatively, as described below in more detail, the target current value of the output current Iₒ of each power supply unit 400 can be determined based on a proportional current sharing coefficient such that the proportional current sharing condition is satisfied. Within each power supply unit 400, by regulating the output current Iₒ based on the regulation control signal, the measured current value of the output current Iₒ may converge to the target current value of the respective power supply unit 400 and be stabilized at the target current value of the respective power supply unit 400.

As shown in FIG. 4A, DC power supply circuit 402 may include a DC power source 404, a DC to DC (DC/DC) converter 406, and an output network 408. DC power source 404 may be configured to output a power supply signal. DC/DC converter 406 may be configured to convert the power supply signal received from DC power source 404 to a converted power supply signal. Output network 408 may include output port 430, and provide the output voltage Vₒ and the output current Iₒ at output port 430 based on the converted power supply signal.

For example, referring to FIG. 4B, DC power source 404 may be a DC voltage source having a voltage Vin. DC/DC converter 406 can be any type of converter, such as a flyback, forward, buck, boost, buck-boost, half bridge, or full bridge converter, which is not limited herein. DC/DC converter 406 may convert the voltage Vin provided by the DC voltage source to a converted power supply signal. Output network 408 can include at least one of an inductance or a capacitor. Output network 408 may have any suitable structure, which is not limited herein. Output network 408 receives the converted power supply signal as an input and outputs the output voltage Vₒ and the output current Iₒ at the output port. In FIG. 4B, the output port of output network 408 is connected to a rating load R_{L}. In some implementations, output network 408 may include an output filter circuit, which can be configured to suppress and remove output noise (e.g., to smooth out waveforms of the output voltage Vₒ and the output current Iₒ).

Consistent with some aspects of the present disclosure, virtual power source equivalent model 350 of FIG. 3B is designed to provide the output voltage Vₒ having the target voltage value and the output current Iₒ having the target current value at its output port. Power supply unit 400 can be equivalent to virtual power source equivalent model 350. That is, power supply unit 400 is configured to mimic the behavior of virtual power source equivalent model 350, such that DC power supply circuit 402 can be controlled (e.g., by the regulation control signal) to provide the output voltage Vₒ having the target voltage value and the output current Iₒ having the target current value at its output port, like that of virtual power source equivalent model 350. For example, based on the regulation control signal, DC power supply circuit 402 may be configured to regulate the output voltage Vₒ to have the target voltage value and the output current Iₒ to have the target current value at its output port. The regulation control signal can be generated based at least in part on model parameters of virtual power source equivalent model 350 (e.g., the virtual impedance Zᵥ, the reference voltage value Vₛ, the reference current value Iₛ), as described below in more detail.

As shown in FIG. 4A, regulation control circuit 410 may include a controller 412, a reference setting circuit 414, an impedance setting circuit 416, and a modulator 418. Although FIG. 4A shows that controller 412, reference setting circuit 414, and impedance setting circuit 416 are different components, reference setting circuit 414 and impedance setting circuit 416 can be integrated into controller 412 in some implementations.

Referring to FIG. 4B, reference setting circuit 414 may be configured to set the reference voltage value Vₛ and the reference current value Iₛ, and provide the reference voltage value Vₛ and the reference current value Iₛ to controller 412. For example, the reference voltage value Vₛ and the reference current value Iₛ may be determined based on a user input or based on an actual need. Impedance setting circuit 416 may be configured to set a resistance value Rᵥ and an inductance value Lᵥ for the virtual impedance Zᵥ, and provide the resistance value Rᵥ and the inductance value Lᵥ to controller 412. For example, the resistance value Ry and the inductance value Lᵥ may be determined based on a user input or based on an actual need.

Referring to FIG. 4B, controller 412 may be coupled to DC power supply circuit 402. Controller 412 may be configured to measure the output voltage Vₒ of DC power supply circuit 402 through a voltage sensor, and measure the output current Iₒ of DC power supply circuit 402 through a current sensor. As a result, controller 412 can obtain a measured voltage value of the output voltage Vₒ and a measured current value of the output current Iₒ. Controller 412 may determine a difference signal based on (1) the virtual impedance Zᵥ of virtual power source equivalent model 350, (2) a voltage difference between the measured voltage value of the output voltage Vₒ and the reference voltage value Vₛ, and (3) a current difference between the measured current value of the output current Iₒ and the reference current value Iₛ. For example, the difference signal can be obtained using the following equation (6):

$$d ( s ) = \frac{\vert {Z}_{v} \vert}{( \vert {Z}_{v} \vert + 1 )} \frac{( {V}_{s} - {V}_{o}^{′} )}{( {R}_{v} + s {L}_{v} )} + \frac{\vert {Z}_{v} \vert}{( \vert {Z}_{v} \vert + 1 )} ( {I}_{s} - {I}_{o}^{′} ) . \qquad ( 6 )$$

In the above equation (6), Zᵥ represents the virtual impedance which includes a resistance Ry and an inductance Lᵥ. Vₛ and Iₛ represent the reference voltage value and the reference current value of virtual power source equivalent model 350, respectively.

$${V}_{o}^{′} and {I}_{o}^{′}$$

represent the measured voltage value of the output voltage Vₒ and the measured current value of the output current Iₒ, respectively. The equation (6) is similar to the equation (5), except that Vₒ and Iₒ in equation (5) are replaced by

$${V}_{o}^{′} and {I}_{o}^{′}$$

in equation (6) to incorporate the measured voltage value of the output voltage Vₒ and the measured current value of the output current Iₒ into the equation (6), respectively.

Next, controller 412 may generate a modulation reference signal based on the difference signal and send the modulation reference signal to modulator 418. In some implementations, controller 412 can include a proportional-integral (PI) controller, and the modulation reference signal can be an output signal generated by the PI controller using the difference signal as an input. It is contemplated that controller 412 can also be another suitable type of controller, which is not limited herein. In some implementations, controller 412 can be implemented using a microcontroller (MCU) or a digital signal processor (DSP) through firmware. Alternatively, controller 412 can be implemented using analog circuits such as operational amplifiers, transistors, resistors, capacitors, etc.

Modulator 418 may generate the regulation control signal (e.g., a modulated waveform) based on the modulation reference signal. The modulation reference signal may be used to adjust one or more modulation parameters of modulator 418. For example, the modulation reference signal may be used to adjust a frequency, a pulse phase, a pulse width, or a duty cycle of the modulated waveform output by modulator 418. Modulator 418 may send the regulation control signal to DC/DC converter 406 for the regulation of the output voltage Vₒ and the output current Iₒ. In some implementations, modulator 418 can be a pulse width modulator (PWM). The regulation control signal can be a pulse-width modulated waveform, which may act as a gate switching signal configured to drive DC/DC converter 406 to regulate the output voltage Vₒ and the output current Iₒ, such that the difference signal is reduced (e.g., the difference signal is driven to be zero). For example, the regulation control signal may change a frequency of DC/DC converter 406 to regulate the output voltage Vₒ and the output current Iₒ, such that the difference signal is driven to be zero.

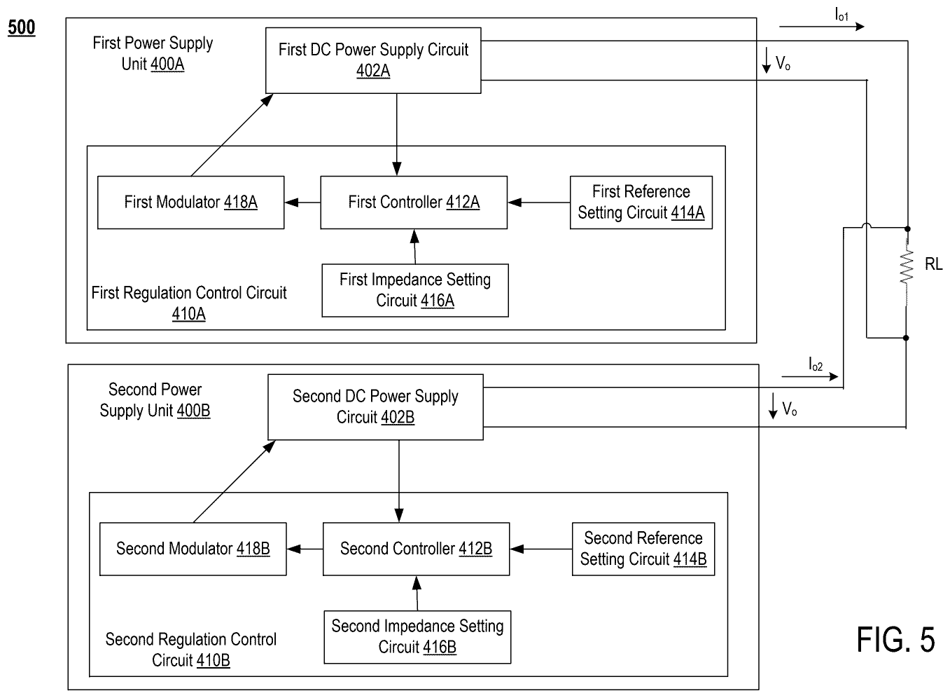

FIG. 5 illustrates a block diagram of a power supply network 500, according to some aspects of the present disclosure. Power supply network 500 may include a plurality of power supply units 400 that are connected in parallel. For example, power supply network 500 may include a first power supply unit 400A and a second power supply unit 400B, which are connected in parallel. Output ports of first and second power supply units 400A and 400B are connected to a rating load R_{L}, respectively.

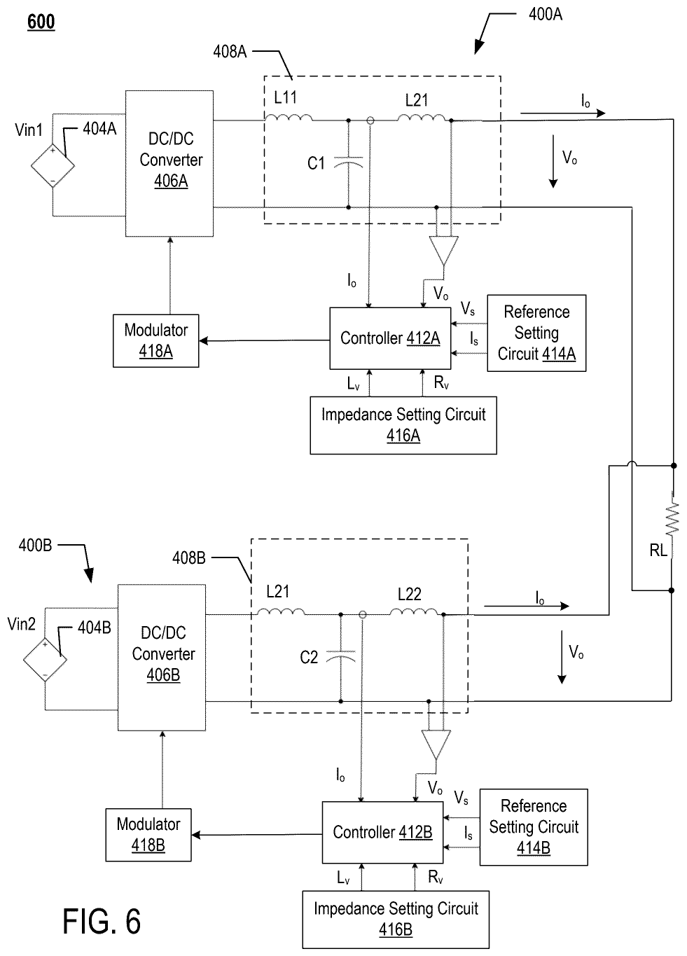

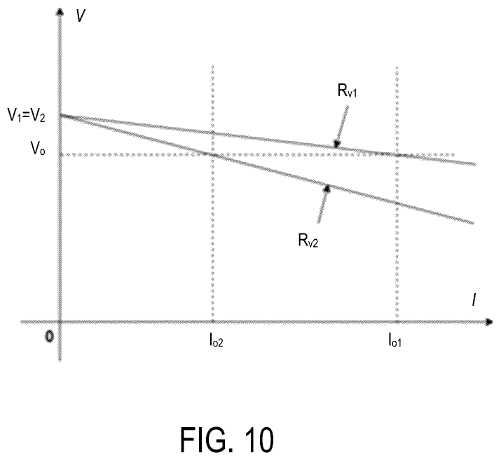

In some implementations, first power supply unit 400A may include a first DC power supply circuit 402A and a first regulation control circuit 410A coupled to first DC power supply circuit 402A. First DC power supply circuit 402A may include a first output port, and configured to provide an output voltage Vₒ and a first output current Iₒ at the first output port. First DC power supply circuit 402A may include a first DC power source 404A, a first DC/DC converter 406A, and a first output network 408A, as shown in FIGS. 6 and 10 below. First DC power source 404A, first DC/DC converter 406A, and first output network 408A may have functionalities like those of DC power source 404, DC/DC converter 406, and output network 408 of FIGS. 4A and 4B, and the similar description will not be repeated herein.

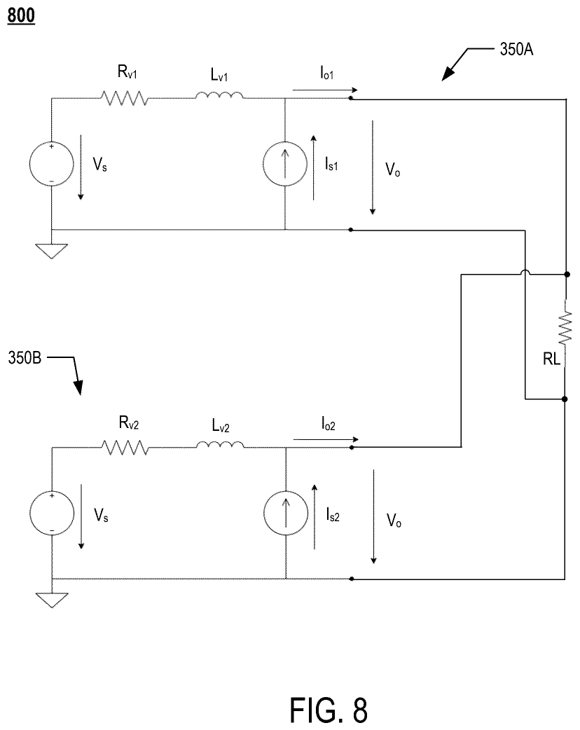

First power supply unit 400A may be equivalent to a first virtual power source equivalent model 350A (shown in FIG. 8). For example, first virtual power source equivalent model 350A is designed to provide an output voltage Vₒ having a target voltage value and a first output current Iₒ₁ having a first target current value at its output port. First power supply unit 400A is configured to mimic the behavior of first virtual power source equivalent model 350A, such that first DC power supply circuit 402A can be controlled (e.g., by a first regulation control signal) to provide the output voltage Vₒ having the target voltage value and the first output current Iₒ₁ having the first target current value at its output port, like that of first virtual power source equivalent model 350A.

First virtual power source equivalent model 350A may include a first DC Thévenin equivalent model and a first DC current source in parallel connection with the first DC Thévenin equivalent model. The DC Thévenin equivalent model may include a first equivalent voltage source and a first virtual impedance Zᵥ₁ in series connection with the first equivalent voltage source. The first equivalent voltage source may have a reference voltage value Vₛ, and the first DC current source may have a first reference current value Iₛ₁. The first virtual impedance Zᵥ₁ may have a first resistance Rᵥ₁ and a first inductance Lᵥ₁, e.g., Zᵥ1=Rᵥ1+jωLᵥ₁.

Referring to FIG. 5, first regulation control circuit 410A may generate a first regulation control signal based at least in part on a first measured voltage value of the output voltage Vₒ and a first measured current value of the first output current Iₒ₁ at the first output port. First regulation control circuit 410A may include a first controller 412A, a first reference setting circuit 414A, a first impedance setting circuit 416A, and a first modulator 418A.

First controller 412A may determine a first difference signal based on the first virtual impedance Zᵥ₁ of first virtual power source equivalent model 350A, a first voltage difference between the first measured voltage value of the output voltage Vₒ and the reference voltage value Vₛ, and a first current difference between the first measured current value of the first output current Iₒ₁ and the first reference current value Iₛ₁. First controller 412A may generate a first modulation reference signal based on the first difference signal. First modulator 418A may generate the first regulation control signal based on the first modulation reference signal. Then, first DC power supply circuit 402A may regulate, based on the first regulation control signal, the output voltage Vₒ to have a target voltage value and the first output current Lₒ₁ to have a first target current value at the first output port.

First controller 412A, first reference setting circuit 414A, first impedance setting circuit 416A, and first modulator 418A may have functionalities like those of controller 412, reference setting circuit 414, impedance setting circuit 416, and modulator 418 of FIGS. 4A-4B, and the similar description will not be repeated herein.

In some implementations, second power supply unit 400B may include a second DC power supply circuit 402B and a second regulation control circuit 410B coupled to second DC power supply circuit 402B. Second DC power supply circuit 402B may include a second output port, and configured to provide the output voltage Vₒ and a second output current Iₒ at the second output port. Second DC power supply circuit 402B may include a second DC power source 404B, a second DC/DC converter 406B, and a second output network 408B, which are shown in FIGS. 6 and 10 below. Second DC power source 404B, second DC/DC converter 406B, and second output network 408B may have functionalities like those of DC power source 404, DC/DC converter 406, and output network 408 of FIGS. 4A and 4B, and the similar description will not be repeated herein.

Second power supply unit 400B may be equivalent to a second virtual power source equivalent model 350B (shown in FIG. 8). For example, second virtual power source equivalent model 350B is designed to provide the output voltage Vₒ having the target voltage value and a second output current Iₒ₂ having a second target current value at its output port. Second power supply unit 400B is configured to mimic the behavior of second virtual power source equivalent model 350B, such that second DC power supply circuit 402B can be controlled (e.g., by a second regulation control signal) to provide the output voltage Vₒ having the target voltage value and the second output current Iₒ₂ having the second target current value at its output port, like that of second virtual power source equivalent model 350B.

Second virtual power source equivalent model 305B may include a second DC Thévenin equivalent model and a second DC current source in parallel connection with the second DC Thévenin equivalent model. The DC Thévenin equivalent model may include a second equivalent voltage source and a second virtual impedance Zᵥ in series connection with the second equivalent voltage source. The second equivalent voltage source may have the same reference voltage value Vₛ, and the second DC current source may have a second reference current value Iₛ₁. The second virtual impedance Zᵥ₂ may have a second resistance Rᵥ₂ and a second inductance Lᵥ₂, e.g., Zᵥ2=R$2+jωLᵥ₂.

Referring to FIG. 5, second regulation control circuit 410B may generate a second regulation control signal based at least in part on a second measured voltage value of the output voltage Vₒ and a second measured current value of the second output current Iₒ₂ at the second output port. Second regulation control circuit 410B may include a second controller 412B, a second reference setting circuit 414B, a second impedance setting circuit 416B, and a second modulator 418B.

Second controller 412B may determine a second difference signal based on the second virtual impedance Zᵥ₂ of second virtual power source equivalent model 350B, a second voltage difference between the second measured voltage value of the output voltage Vₒ and the reference voltage value Vₛ, and a second current difference between the second measured current value of the second output current Iₒ₂ and the second reference current value Iₛ₂. Second controller 412B may generate a second modulation reference signal based on the second difference signal. Second modulator 418B may generate the second regulation control signal based on the second modulation reference signal. Then, second DC power supply circuit 402B may regulate, based on the second regulation control signal, the output voltage Vₒ to have the target voltage value and the second output current Iₒ₂ to have a second target current value at the second output port.

Second controller 412B, second reference setting circuit 414B, second impedance setting circuit 416B, and second modulator 418B may have functionalities like those of controller 412, reference setting circuit 414, impedance setting circuit 416, and modulator 418 of FIGS. 4A-4B, and the similar description will not be repeated herein.

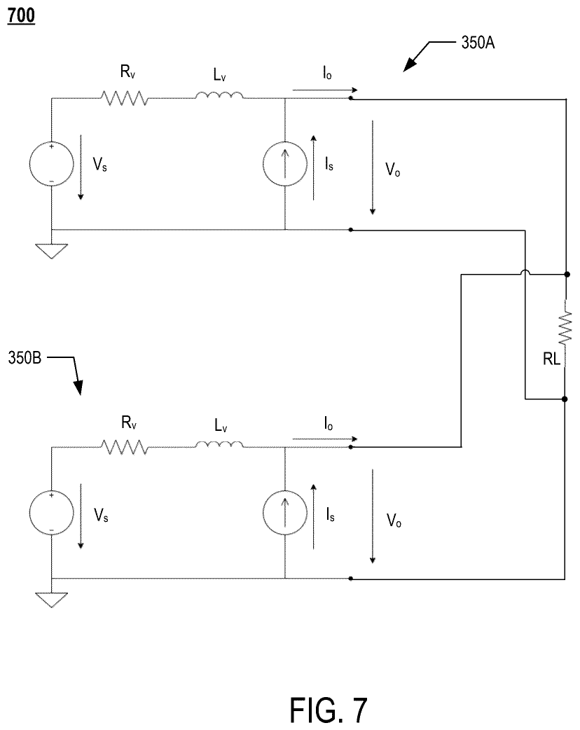

Consistent with some aspects of the present disclosure, the first target current value of the first output current Iₒ₁ of first power supply unit 400A is equal to the second target current value of the second output current Iₒ₂ of second power supply unit 400B (e.g., Iₒ₁=Iₒ₂=Iₒ), such that equal current sharing is achieved in power supply network 500. FIG. 6 illustrates a circuit diagram 600 of power supply network 500 with equal current sharing among parallel-connected power supply units 400A and 400B, according to some aspects of the present disclosure. Each of power supply units 400A and 400B may have a structure like that of power supply unit 400 in FIG. 4B, and the similar description will not be repeated herein. FIG. 7 illustrates a diagram 700 of virtual power source equivalent models 350A and 350B with equal current sharing, according to some aspects of the present disclosure. Each of virtual power source equivalent models 350A and 350B may have a structure like that of virtual power source equivalent model 350 of FIG. 3B, and the similar description will not be repeated herein.

With reference to FIG. 7, second virtual power source equivalent model 350B is identical to first virtual power source equivalent model 350A. That is, first and second virtual power source equivalent models 350A and 350B are the same virtual power source equivalent model having the same model parameters, as shown in FIG. 7. For example, the first virtual impedance Zᵥ₁ is identical to the second virtual impedance Zᵥ₂ (e.g., Rᵥ₁=Rᵥ₂=Rᵥ, Lᵥ₁=Lᵥ₂=Lᵥ, Zᵥ₁=Zᵥ₂=Zᵥ), and the first reference current Iₛ₁ is identical to the second reference current Iₛ₂ (Iₛ₁=Iₛ₂=Iₛ). In this case, each of first and second virtual power source equivalent models 350A and 350B includes (a) the same DC Thévenin equivalent model and (b) the same DC current source having the reference current value Iₛ in parallel connection with the DC Thévenin equivalent model. The DC Thévenin equivalent model includes (a) the same equivalent voltage source having the reference voltage value Vₛ and (b) the first or second virtual impedance Zᵥ₁ or Zᵥ₂ (Zᵥ₁=Zᵥ₂=Zᵥ) in series connection with the equivalent voltage source.

With reference to FIG. 6, first reference setting circuit 414A of first power supply unit 400A or second reference setting circuit 414B of second power supply unit 400B may set the reference voltage value Vₛ and the reference current value Iₛ. For example, the reference voltage value Vₛ and the reference current value Iₛ may be set based on a user input or based on an actual need. First impedance setting circuit 416A of first power supply unit 400A or second impedance setting circuit 416B of second power supply unit 400B may set the resistance value and the inductance value of the virtual impedance Zᵥ. For example, the resistance value Ry and the inductance value Lᵥ of the virtual impedance Zᵥ may be set based on a user input or based on an actual need.

Consistent with some aspects of the present disclosure, referring to FIG. 5, the first target current value of the first output current Iₒ₁ of first power supply unit 400A is equal to the second target current value of the second output current Iₒ₂ of second power supply unit 400B multiplied by a proportional current sharing coefficient k (e.g., Iₒ1=k*Iₒ₂), such that proportional current sharing is achieved in power supply network 500. In some implementations, the proportional current sharing coefficient k may be a ratio between a first rated capacity of first power supply unit 400A and a second rated capacity of second power supply unit 400B.

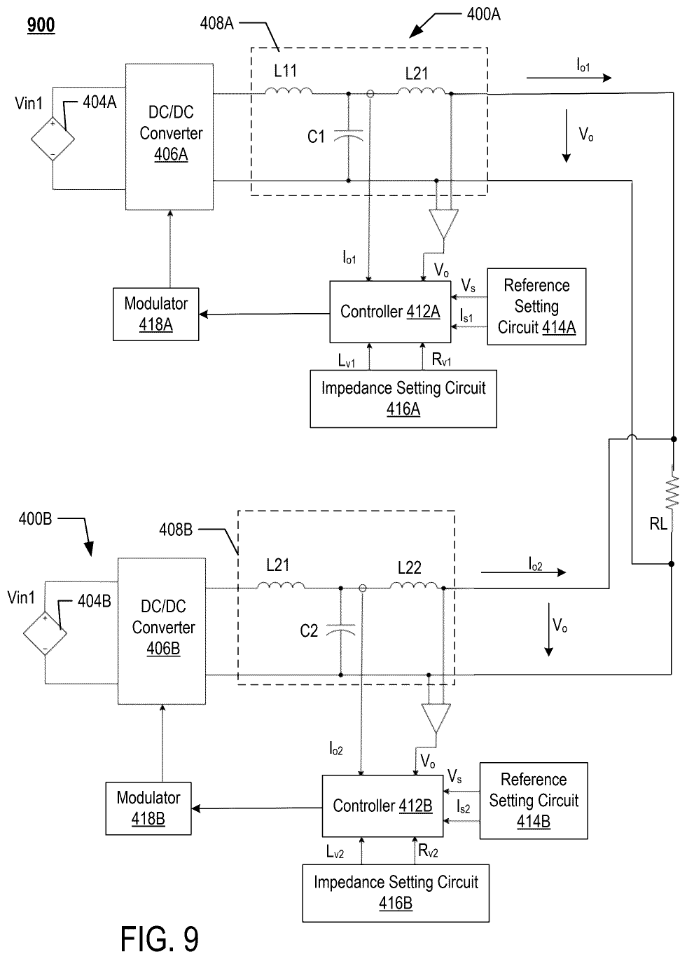

FIG. 8 illustrates a diagram 800 of virtual power source equivalent models 350A and 350B with proportional current sharing, according to some aspects of the present disclosure. Each of virtual power source equivalent models 350A and 350B may have a structure like that of virtual power source equivalent model 350 of FIG. 3B, and the similar description will not be repeated herein. FIG. 9 illustrates a circuit diagram 900 of power supply network 500 with proportional current sharing among power supply units 400A and 400B, according to some aspects of the present disclosure. Each of power supply units 400A and 400B may have a structure like that of power supply unit 400 in FIG. 4B, and the similar description will not be repeated herein.

If the proportional current sharing coefficient k is equal to 1, then the proportional current sharing scheme becomes the equal current sharing scheme. Then, second virtual power source equivalent model 350B is identical to first virtual power source equivalent model 350A, as shown in FIG. 7. On the other hand, if the proportional current sharing coefficient k is not equal to 1, then the proportional current sharing scheme is implemented. As shown in FIG. 8, second virtual power source equivalent model 350B have some parameters different from those of first virtual power source equivalent model 350A. That is, first and second virtual power source equivalent model 350A and 350B may have different virtual impedances and different reference current values, as shown in FIG. 8. For example, first virtual power source equivalent model 350A may have the first virtual impedance Zᵥ₁ (with the first resistance Rᵥ₁ and the first inductance Lᵥ₁) and the first reference current value Iₛ₁. Second virtual power source equivalent model 350B may have the second virtual impedance Zᵥ₂ (with the second resistance Rᵥ₂ and the second inductance Lᵥ₂) and the second reference current value Iₛ₂.

With reference to FIG. 9, first reference setting circuit 414A of first power supply unit 400A may set the reference voltage value Vₛ and the first reference current value Iₛ₁. For example, the reference voltage value Vₛ and the first reference current value Iₛ₁ may be set based on a user input or based on an actual need. First impedance setting circuit 416A of first power supply unit 400A may set the first resistance value and the first inductance value of the first virtual impedance Zᵥ₁. For example, the first resistance value Rᵥ₁ and the first inductance value Lᵥ₁ of the first virtual impedance Zᵥ₁ may be set based on a user input or based on an actual need. As described below in more detail, second reference setting circuit 414B of second power supply unit 400B may set the second reference current value Iₛ₂ based on the proportional current sharing coefficient k and the first reference current value Iₛ₁. Second impedance setting circuit 416B of second power supply unit 400B may set the second resistance value Rᵥ₂ and the second inductance value Lᵥ₂ of the second virtual impedance Zᵥ₂ based on the proportional current sharing coefficient k and the first virtual impedance Zᵥ₁.

It is understood that each power supply unit in power supply network 500 may have a respective controller (e.g., a respective virtual model emulator) which is independently implemented on the corresponding power supply unit. Theoretically, any number of power supply units, each of which can be equivalent to a respective virtual power source equivalent model, can be connected in parallel directly at their respective output ports with no communication among the power supply units. Droop control and current sharing control (e.g., equal or proportional current sharing) can be achieved among the power supply units through the emulation of the respective virtual power source equivalent models in the power supply units.

FIG. 10 illustrates exemplary output characteristics of virtual power source equivalent models 350A and 350B of FIG. 8, according to some aspects of the present disclosure. The configuration of model parameters (e.g., the second virtual impedance Zᵥ₂ and the second reference current Iₛ₂) when the proportional current sharing scheme is implemented is provided herein with reference to FIG. 8 and FIG. 10. For example, with reference to FIG. 8, an output voltage V₁ of first virtual power source equivalent model 350A and an output voltage V₂ of second virtual power source equivalent model 350B at an open-circuit (OC) state satisfies the following equations:

$$\{ \begin{matrix}{V}_{1} = {V}_{s} + {R}_{v 1} {I}_{s 1} \\ {V}_{2} = {V}_{s} + {R}_{v 2} {I}_{s 2}\end{matrix} , \qquad ( 7 )$$

$${V}_{1} = {V}_{2} . \qquad ( 8 )$$

Based on the equations (7) and (8), the following equation (9) can be obtained:

$${R}_{v 1} {I}_{s 1} = {R}_{v 2} {I}_{s 2} . \qquad ( 9 )$$

Then, based on the equation (9), a relationship between the first reference current value Iₛ₁ and the second reference current value Iₛ₂ can be shown by the following equation:

$$\frac{{I}_{s 1}}{{I}_{s 2}} = \frac{{R}_{v 2}}{{R}_{v 1}} . \qquad ( 10 )$$

Also, a first output current Iₒ₁ of first virtual power source equivalent model 350A and a second output current Iₒ₂ of second virtual power source equivalent model 350B satisfy the following equations:

$$\{ \begin{matrix}{I}_{o 1} = \frac{{V}_{1} - {V}_{o}}{{R}_{v 1}} \\ {I}_{o 2} = \frac{{V}_{2} - {V}_{o}}{{R}_{v 2}}\end{matrix} . \qquad ( 11 )$$

Based on the equations (8) and (11), the following equation (12) can be obtained:

$$\frac{{I}_{o 1}}{{I}_{o 2}} = \frac{{R}_{v 2}}{{R}_{v 1}} . \qquad ( 12 )$$

The proportional current sharing coefficient k can be defined according to the following equation (13):

$$k = \frac{{I}_{o 1}}{{I}_{o 2}} . \qquad ( 13 )$$

Then, by combing equations (10), (12) and (13), the following equation (14) can be obtained:

$$\frac{{I}_{s 1}}{{I}_{s 2}} = \frac{{R}_{v 2}}{{R}_{v 1}} = k = \frac{{I}_{o 1}}{{I}_{o 2}} . \qquad ( 14 )$$

It is understood that a value of the proportional current sharing coefficient k can be selected arbitrarily or based on a user input or actual need. For example, the proportional current sharing coefficient k can be determined based on the rated capacities of the power supply units according to the following equation (15):

$$k = \frac{{I}_{o 1}}{{I}_{o 2}} = \frac{{V}_{o} {I}_{o 1}}{{V}_{o} {I}_{o 2}} = \frac{{P}_{1}}{{P}_{2}} . \qquad ( 15 )$$

In the above equation (15), Pᵢ denotes a rated power of the i^{th} power supply unit, with i=1 or 2. That is, the contribution of each parallel-connected power supply unit to the power supply network depends on the capacity of the corresponding power supply unit. A power supply unit with a larger capacity may provide a larger current to the rating load, whereas a power supply unit with a smaller capacity may provide a smaller current to the rating load.

Based on the above equations (14) and (15), a process of configuring the model parameters of virtual power source equivalent models 350A and 350B when the proportional current sharing scheme is implemented is provided herein according to the following Steps 1-3. In Step 1, the proportional current sharing coefficient k can be determined based on the rated capacities of the power supply units according to the above equation (15). In Step 2, the reference voltage value Vₛ, the first resistance value Rᵥ₁, and the first reference current value Iₛ₁ can be set to be any suitable values, respectively, which is not limited herein. In Step 3, the second resistance value Rᵥ₂ and the second reference current value Iₛ₂ can be set according to the above equation (14) (e.g., Rᵥ2=k*Rᵥ₁, and Iₛ2=Iₛ₁/k). It is contemplated that the above Steps 1-3 can be repeated for the configuration of any other power supply units in the power supply network. Once the model parameters for all virtual power supply equivalent models are set, each power supply unit incorporating a respective virtual power supply equivalent model may provide a respective current to the rating load according to its capacity. When the proportional current sharing coefficient k is equal to 1 (e.g., k=1), the proportional current sharing according to the proportional current sharing coefficient k becomes equal current sharing, as shown in FIGS. 6-7. As a result, power supply units of any type or any size can be connected in parallel directly for equal or proportional current sharing according to their capacities to avoid overload of each power supply unit.

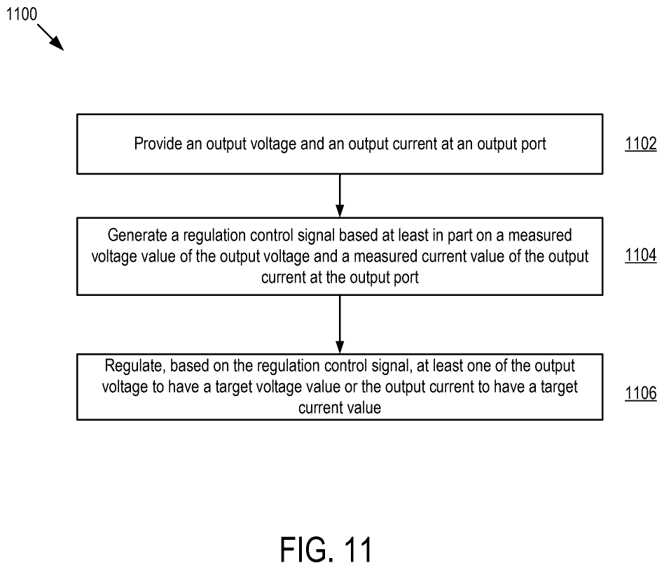

FIG. 11 illustrates a flowchart of a method 1100 for operating a power supply unit, according to some aspects of the present disclosure. The power supply unit may include a DC power supply circuit and a regulation control circuit. For example, the power supply unit may be power supply unit 400 shown in FIGS. 4A-4B. It is understood that the operations shown in method 1100 may not be exhaustive and that other operations can be performed as well before, after, or between any of the illustrated operations. Further, some of the operations may be performed simultaneously, or in a different order than that shown in FIG. 11.

Method 1100 may begin with operation 1102 in which an output voltage Vₒ and an output current Iₒ are provided by the DC power supply circuit at an output port.

Method 1100 may proceed to operation 1104, in which a regulation control signal is generated by the regulation control circuit based at least in part on a measured voltage value of the output voltage Vₒ and a measured current value of the output current Iₒ at the output port. For example, operations like those described above with reference to FIGS. 4A-4B can be performed to generate the regulation control signal.

Method 1100 may proceed to operation 1106, in which at least one of the output voltage Vₒ or the output current Iₒ may be regulated, by the DC power supply circuit and based on the regulation control signal, to have a target voltage value or a target current value, respectively.

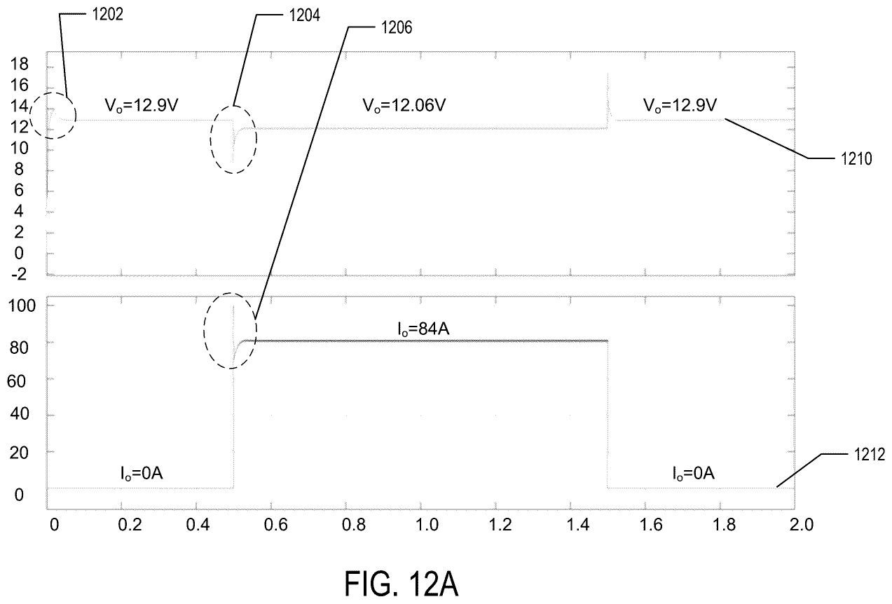

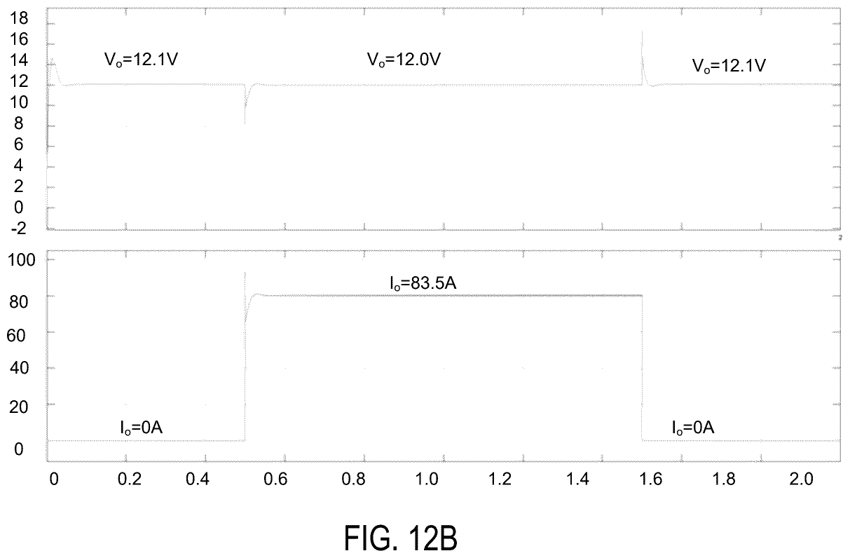

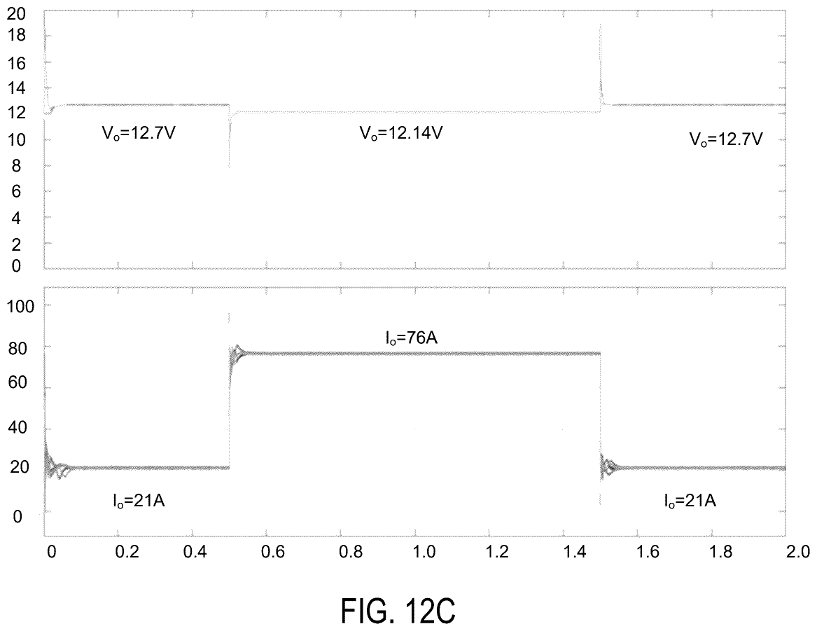

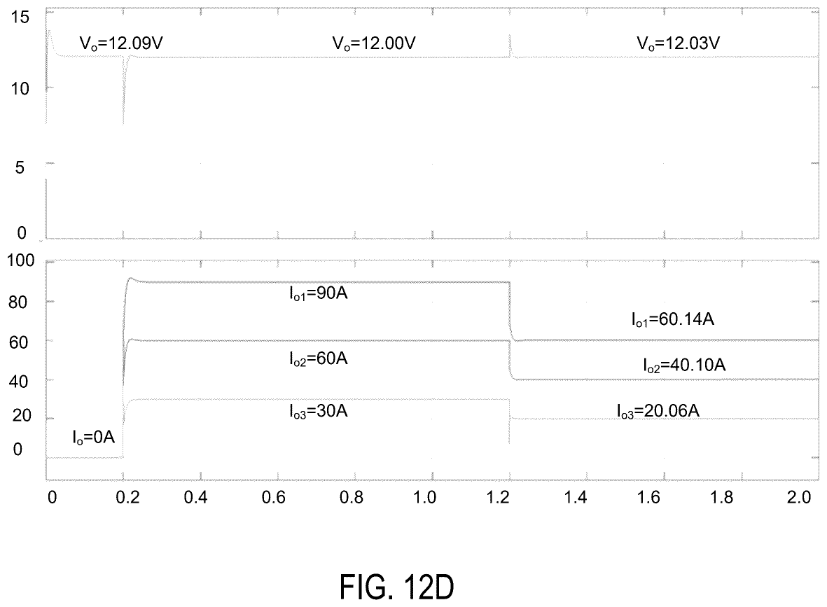

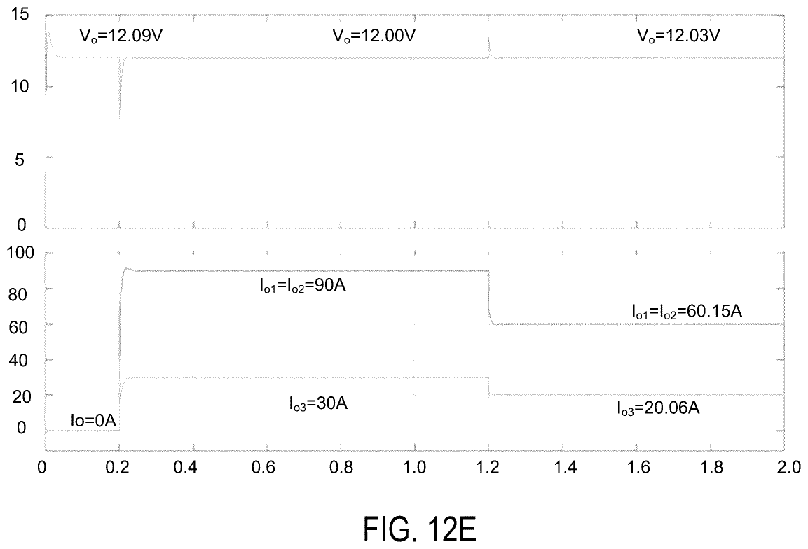

FIGS. 12A-12E illustrate simulation results of various power supply networks, according to some aspects of the present disclosure. In the virtual-model based control scheme disclosed herein, power supply units are connected in parallel to form a power supply network in which each power supply unit is equivalent to a respective virtual power source equivalent model. Droop control and equal or proportional current sharing can be achieved in the power supply network. FIGS. 12A-12C are simulation results related to the verification of the equal current sharing, FIG. 12D is a simulation result related to the verification of the proportional current sharing, and FIG. 12E is a simulation result related to the verification of a hybrid of the equal current sharing and the proportional current sharing.

With respect to the equal current sharing simulations in FIGS. 12A-12C, each power supply unit is a 12V/1100 W power supply unit and its dynamic response performance is also validated. The rated capacity of each power supply unit is set to be 1100 W. Each power supply unit is equivalent to the same virtual power source equivalent model 350 of FIG. 3B. The reference voltage value Vₛ in the Thevenin equivalent model is set to be 12V, and the reference current value Iₛ is set to be 90 A. Six power supply units (each incorporating the same virtual power source equivalent model 350 of FIG. 3B) are built in parallel to form the power supply network in the simulation. As discussed above, because the virtual-model based control scheme disclosed herein does not rely on the hardware implementation, topology and modulation selection of the power supply units, these power supply units can be modeled with different converter bridge structures, different component selections, and different PWM modes. It is contemplated that any number of power supply units (e.g., 2, 3, 4, 5, 6, 7, . . . ) can be included in the power supply network, which is not limited herein.

Referring to FIG. 12A, each power supply unit may be a first power supply model, and the resistance value Ry is set to be Rᵥ=0.01Ω. The simulation result shown in FIG. 12A indicates that all the output currents Iₒ of the six parallel-connected power supply units are the same. The virtual model emulator exhibits fast dynamic response characteristics and optimal performance across large load ranges, due to the implementation of the composite voltage-current controller.

When Iₒd=OA which is equivalent to an open-circuit (OC) state, according to the virtual power source equivalent model, the OC output voltage is Vₒ=Vₛ+Iₛ×Rᵥ=12V+90 A×0.01Ω=12.9V, which is identical to the simulated output voltage value “Vₒ=12.9V” shown in FIG. 12A. For example, the target current value of the output current Iₒ is OA. The target voltage value of the output voltage Vₒ is 12.9V, and a fluctuation 1202 in a voltage curve 1210 illustrates a process of regulating the output voltage Vₒ to have the target voltage value 12.9V.

When Iₒ=84 A, according to the virtual power source equivalent model, the output voltage is Vₒ=Vₛ+ (Iₛ−Iₒ)×Rᵥ=12V+ (90 A−84 A)×0.01Ω=12.06V. This is also identical to the simulated output voltage value “Vₒ=12.06V” shown in FIG. 12A. For example, the target current value of the output current Iₒ is 84 A, and the target voltage value of the output voltage Vₒ is 12.9V. A fluctuation 1204 in voltage curve 1210 and a fluctuation 1206 in a current curve 1212 illustrate another process of regulating the output voltage Vₒ to have the target voltage value 12.06V and the output current Iₒ to have the target current value 84 A. This simulation result verifies that the control scheme disclosed herein ensures that all the power supply units behave as the same virtual power source equivalent model.

Referring to FIG. 12B, each power supply unit may also be the first power supply model, and the resistance value Rᵥ is set to be Rᵥ=0.001Ω. The simulation result shown in FIG. 12B indicates that all the output currents Iₒ of the six parallel-connected power supply units are the same. The composite voltage-current controller has a quick and stable response to sudden changes in loads, with a small overshoot and a short settling time. The simulation of FIG. 12B has a smaller resistance Ry than that of FIG. 12A. When the resistance Rᵥ is smaller, the virtual power source equivalent model behaves more like an ideal voltage source, indicating that the output voltage Vₒ remains almost constant regardless of the load.

When Iₒ=OA which is equivalent to the open-circuit state, according to the virtual power source equivalent model, the OC output voltage is Vₒ=Vₛ+Iₛ×Rᵥ=12V+90 A×0.001Ω≈12.1V. This is identical to the simulated output voltage value “Vₒ=12.1V” shown in FIG. 12B. When Iₒ=83.5 A, according to the virtual power source equivalent model, the output voltage is Vₒ=Vₛ+ (Iₛ−Iₒ)×Rᵥ=12V+(90 A−83.5 A)×0.0010≈12.0V. This is also identical to the simulated output voltage value “Vₒ=12.0V” shown in FIG. 12B. This simulation result verifies that the control scheme disclosed herein ensures that all the power supply units behave as the same virtual power source equivalent model.

Referring to FIG. 12C, each power supply unit may be a second power supply model having a topology different from that of the first power supply model, and the resistance value Rᵥ is set to be Rᵥ=0.01Ω. The simulation result shown in FIG. 12C indicates that all the output currents Iₒ of the six parallel-connected power supply units are the same. The simulated power supply network shows a rapid and stable response to a step change in load.

When Iₒ=21 A, according to the virtual power source equivalent model, the output voltage is Vₒ=Vₛ+ (Iₛ−Iₒ)×Rᵥ=12V+(90 A−21 A)×0.01Ω≈12.7V. This is identical to the simulated output voltage value “Vₒ=12.7V” shown in FIG. 12C. When Iₒ=76 A, according to the virtual power source equivalent model, the output voltage is Vₒ=Vₛ+(Iₛ−Iₒ)×Rᵥ=12V+(90 A−76 A)×0.01Ω≈12.14V. This is also identical to the simulated output voltage value “Vₒ=12.14V” shown in FIG. 12C. This simulation result verifies that the control scheme disclosed herein ensures that all the power supply units behave as the same virtual power source equivalent model, regardless of the topology of the power supply model.

With respect to the proportional current sharing simulation shown in FIG. 12D, three different power supply units are employed in the power supply network to demonstrate the proportional current sharing, with a first power supply unit to be a 12V/1080 W unit, a second power supply unit to be a 12V/720 W unit, and a third power supply unit to be a 12V/360 W unit. Therefore, the proportional current sharing coefficient k can be set as 1080 W: 720 W: 360 W=3:2:1. For the first 12V/1800 W power supply unit, Vₛ=12V, Rᵥ1=0.001Ω, and Iₛ₁=90 A can be set based on an actual need. According to the above equation (14), Vₛ=12V, Rᵥ₂=0.001502, and Iₛ₂=60 A can be set for the second 12V/720 W power supply unit, and Vₛ=12V, Rᵥ₃=0.0030, and Iₛ₃=30 A can be set for the third 12V/360 W power supply unit. When these different power supply units are connected in parallel to form the power supply network, a simulation result of the power supply network is shown in FIG. 12D.

In FIG. 12D, in the steady state, the output currents of all the three different power supply units satisfy the proportional current sharing condition determined by the proportional current sharing coefficient k=3:2:1 (that is, Iₒ₁:Iₒ₂:Iₒ₃=k=3:2:1), no matter how the load changes. Also, this simulation result shows the fast dynamic response performance of the control scheme disclosed herein regardless of the different implementations of the power supply units.

With respect to the hybrid simulation of the equal and proportional current sharing shown in FIG. 12E, three power supply units are employed to form a power supply network, with a first power supply unit to be a 12V/1080 W unit, a second power supply unit to be a 12V/1080 W unit, and a third power supply unit to be a 12V/360 W unit. Therefore, the proportional current sharing coefficient k can be set as 1080 W: 1080 W: 360 W=3:3:1. For the first 12V/1800 W power supply unit, Vₛ=12V, Rᵥ₁=0.001Ω, and Iₛ₁=90 A are set. According to the above equation (14), Vₛ=12V, Rᵥ₂=0.001Ω, and Iₛ₂=90 A are set for the second 12V/1080 W power supply unit, and Vₛ=12V, Rᵥ3=0.0030, and Iₛ3=30 A are set for the third 12V/360 W power supply unit. A simulation result of the power supply network is shown in FIG. 12D.

In FIG. 12E, in the steady state, the output currents of the first and second power supply units are 90 A and the output current of the third power supply unit is 20 A, which satisfies the current sharing condition determined by the proportional current sharing coefficient k=3:3:1 (e.g., Iₒ₁:Iₒ₂:Iₒ₃=k=3:3:1) no matter how the load changes. Also, this simulation result shows the fast dynamic response performance of the control scheme disclosed herein regardless of the different implementations of the power supply units.

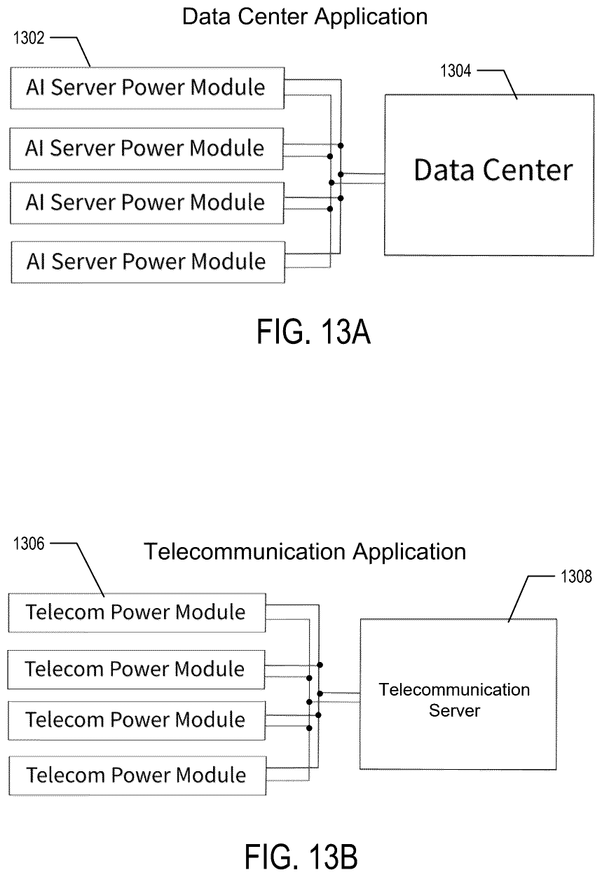

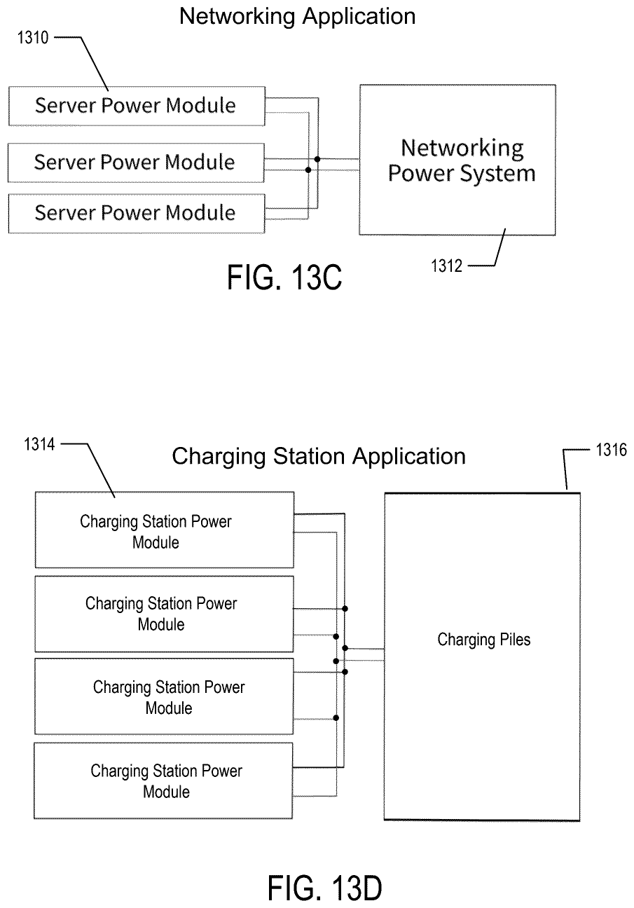

FIGS. 13A-13D illustrates various applications of a power supply network, according to some aspects of the present disclosure. Power supply networks, each formed by parallel-connected power supply units, can be widely used in various application fields due to their ability to ensure uninterrupted power and redundancy, to increase reliability and efficiency, to enhance capacity, and to manage thermal loads.

Referring to FIG. 13A, a first scenario may involve the application of a power supply network in a data center 1304 (e.g., data center application). Each power supply unit may serve as an artificial intelligence (AI) server power module 1302 that provides power to data center 1304. In some implementations, the power supply network with parallel-connected power supply units can satisfy a requirement of power supply redundancy and reliability for data center 1304. For example, data center 1304 may require continuous power supply to maintain operations. The parallel-connected power supply units (e.g., parallel-connected AI server power modules 1302) can provide redundancy, ensuring that if one power supply unit fails, the others can continue to provide power to data center 1304 without interruption.

In some implementations, the power supply network with parallel-connected power supply units can provide increased power density to data center 1304. By providing power through the parallel-connected power supply units (e.g., parallel-connected AI server power modules 1302), the data center can achieve a higher power density, thereby accommodating more servers in a given space.

In some implementations, the power supply network with parallel-connected power supply units can provide load sharing for data center 1304. By providing power through the parallel-connected power supply units (e.g., parallel-connected AI server power modules 1302), data center 1304 can distribute the load evenly across the power supply units to handle high-performance computing demands, thereby preventing any single power supply unit from being overburdened, potentially overheating or failing.

Referring to FIG. 13B, a second scenario may involve the application of the power supply network in a telecommunication server 1308 (e.g., telecommunication application). Each power supply unit may serve as a telecommunication power module 1306 that provides power to telecommunication server 1308. In some implementations, the power supply network with the parallel-connected power supply units can provide uninterrupted power to telecommunication server 1308. For example, a telecommunication system, such as a cellular base station or a network infrastructure, needs a reliable power supply to maintain constant connectivity. The parallel-connected power supply units (e.g., parallel-connected telecommunication power modules 1306) can provide a fail-safe mechanism to prevent outages.

In some implementations, the power supply network with the parallel-connected power supply units can provide a large current to the loads of telecommunication server 1308. For example, a telecommunication equipment often demands a large current for its power amplifiers, routers, and switches. The parallel-connected power supply units (e.g., parallel-connected telecommunication power modules 1306) together can deliver the large current to the telecommunication equipment.

In some implementations, the power supply network with the parallel-connected power supply units can satisfy the power scalability requirement of telecommunication server 1308. For example, as a telecommunication network expands, scalability of the power supply network can be easily achieved by adding more parallel-connected power supply units (e.g., more telecommunication power modules 1306) to the power supply network, thereby meeting the increasing demand of power supply in the telecommunication network. In some implementations, the power supply network with the parallel-connected power supply units can provide improved reliability. For example, redundancy in the power supply network ensures system uptime and prevents costly downtime of telecommunication server 1308.

Referring to FIG. 13C, a third scenario may involve the application of the power supply network in a networking power system 1312 (e.g., networking application). Each power supply unit may serve as a server power module 1310 that provides power to networking power system 1312. In some implementations, the power supply network with the parallel-connected power supply units can ensure continuous operation of networking power system 1312. The power supply network with the parallel-connected power supply units can provide power redundancy to handle loads and prevent downtime of networking power system 1312, thereby maintaining information integrity and availability in networking power system 1312. The IT industries rely on the parallel-connected power supply units for their network operation centers to ensure consistent service and network reliability.

In some implementations, the power supply network with the parallel-connected power supply units can facilitate load balancing for networking power system 1312. Power loads can be distributed evenly across the power supply units, thereby enhancing the efficiency and longevity of the IT networking equipment. In some implementations, the power supply network with the parallel-connected power supply units can improve performance of networking power system 1312. Consistent power supply provided by the power supply network helps networking power system 1312 to achieve optimal performance.

Referring to FIG. 13D, a fourth scenario may involve the application of the power supply network in charging piles 1316 (e.g., charging station application). Each power supply unit may serve as a charging station power module 1314 that provides power to charging piles 1316. In some implementations, the power supply network with the parallel-connected power supply units can provide increased power capacity to charging piles. For example, DC charging stations require high power output to rapidly charge electric vehicles (EVs). The power supply network with the parallel-connected power supply units enables a high power output, thereby accommodating demanding loads. By combining the power supply units in parallel, charging stations can deliver the large current required for fast charging.

In some implementations, the power supply network with the parallel-connected power supply units can facilitate modular design. For example, the power supply units can be easily added to or removed from the power supply network to match the changing power requirements, thereby achieving flexibility in scaling the charging stations' capacity. DC charging piles for electric vehicles can use the parallel-connected power supply units to manage the high current demand efficiently. Charging stations can be easily expanded by adding more power supply units when the demand grows.

In some implementations, the power supply network with the parallel-connected power supply units can facilitate load balancing for the charge stations. The load can be distributed evenly across the power supply units, thereby improving efficiency and preventing overloading of each power supply unit. In some implementations, the power supply network with the parallel-connected power supply units can help to reduce the charging time. For example, the charging stations require high power output to charge EVs quickly. The parallel-connected power supply units can meet the charging demands of multiple vehicles simultaneously, resulting in reduced charging time for the vehicles.

With combined reference to FIGS. 13A-13D, the parallel-connected power supply units in the power supply network are primarily used to increase the total output current of the power supply network without affecting the output voltage Vₒ. By employing the parallel-connected power supply units in various fields, organizations can achieve enhanced reliability, scalability, optimized efficiency and improved thermal control in their power management systems. The parallel-connected power supply units can provide reliable power management and distribution in supporting the backbone of modern infrastructure and technology.

Consistent with some aspects of the present disclosure, the virtual-model based control scheme disclosed herein falls under droop control and does not require additional communication. The control scheme disclosed herein allows power supply units to be directly connected in parallel without any limitations on modularity (e.g., allowing the power supply units to achieve true plug and play).

In the control scheme disclosed herein, the accuracy of the current sharing primarily depends on the settings of the respective virtual power source equivalent models. It is easy and effective to use digital control circuits such as MCUs or DSPs to implement the virtual model emulators (or controllers) discussed above. For example, these digital circuits can flexibly implement the virtual model emulators (or controllers) and ensure precision.

The control scheme disclosed herein ensures independence from the hardware implementation, such as topology and component parameters, the modulation pattern of the actual power supply units, etc. The control scheme disclosed herein can serve as a firmware task for a smart or digital power source.

With respect to the virtual power source equivalent model, since a DC Thévenin equivalent model in parallel connection with a DC current source is included, the virtual power source equivalent model serves as a generalized power source model. A zero virtual impedance of the virtual power source equivalent model results in a pure voltage source, whereas an infinite virtual impedance of the virtual power source equivalent model results in a pure current source. Any non-zero finite virtual impedance of the virtual power source equivalent model results in a composite voltage-current source. This allows the designed power supply units to be easily connected in parallel and operate stably to feed any load by simply adjusting the virtual impedance. Besides, by incorporating the DC current source in parallel with the DC Thévenin equivalent model in the virtual power source equivalent model, the voltage drop caused by the load can be offset, thereby enhancing the dynamic performance during load changes.

In the control scheme disclosed herein, when the virtual power source equivalent model (including the DC Thévenin equivalent model and the DC current source connected in parallel) is implemented in the firmware of a power supply unit, any heterogeneous power sources in different types, topologies, capacities and sizes can be connected in parallel for precisely equal or proportional current sharing using the control scheme disclosed herein.

In the control scheme disclosed herein, the virtual impedance Zᵥ=Rᵥ+sLᵥ is equivalent to the series impedance of a voltage source. Since Rᵥ is virtual, this virtual impedance incurs no real power losses (unlike a real resistor that incurs power loss). This allows the emulation of the behavior of the resistance Rᵥ without compromising efficiency. Further, because the virtual impedance Zᵥ=Rᵥ+sLᵥ is in the denominator of the transfer function shown in the equation (5), it acts as a low pass filter, thereby suppressing noise in the voltage signal. This differs from the noise amplification present in conventional virtual impedance control, thereby enhancing the stability of the entire control scheme.

In the control scheme disclosed herein, since the slope of the droop control is determined by the virtual impedance, the adjustment of the virtual impedance can scale the current sharing, which is easily achieved with digital control circuits.

Further, instead of using a primary voltage control loop for the output voltage Vₒ and/or a secondary current control loop for the output current Iₒ (or vice versa), the control scheme disclosed herein employs a composite voltage-current controller that simultaneously controls both the output current and the output voltage together using a single variable (e.g., the difference signal). The virtual impedance can be chosen arbitrarily (e.g., a zero virtual impedance corresponds to a voltage controller, an infinite virtual impedance results in a current controller, and any non-zero finite virtual impedance results in a composite current-voltage controller). Thus, this approach generalizes the voltage controller into a composite voltage-current controller, providing improved control and dynamic characteristics compared to traditional individual voltage controllers or current controllers.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

What is claimed is:

1. A power supply unit, comprising:
a direct current (DC) power supply circuit configured to provide an output voltage and an output current at an output port; and
a regulation control circuit coupled to the DC power supply circuit, and configured to generate a regulation control signal based at least in part on a measured voltage value of the output voltage and a measured current value of the output current at the output port,
wherein the DC power supply circuit is further configured to, based on the regulation control signal, regulate at least one of the output voltage to have a target voltage value or the output current to have a target current value.

2. The power supply unit of claim 1, wherein the regulation control circuit comprises:
a controller coupled to the DC power supply circuit, and configured to:
determine a difference signal based on a virtual impedance of a virtual power source equivalent model, a voltage difference between the measured voltage value and a reference voltage value, and a current difference between the measured current value and a reference current value; and
generate a modulation reference signal based on the difference signal; and
a modulator coupled to the controller and the DC power supply circuit, and configured to generate the regulation control signal based on the modulation reference signal.

3. The power supply unit of claim 2, wherein the difference signal is expressed as follows:
$$d ( s ) = \frac{\vert {Z}_{v} \vert}{( \vert {Z}_{v} \vert + 1 )} \frac{( {V}_{s} - {V}_{o}^{′} )}{( {R}_{v} + {sL}_{v} )} + \frac{\vert {Z}_{v} \vert}{( \vert {Z}_{v} \vert + 1 )} ( {I}_{s} - {I}_{o}^{′} ) ,$$
wherein d(s) represents the difference signal, Zᵥ represents the virtual impedance comprising a resistance Rᵥ and an inductance Lᵥ, Vₛ represents the reference voltage value,
$${V}_{o}^{′}$$
represents the measured voltage value, Iₛ represents the reference Current value, and
$${I}_{o}^{′}$$
represents the measured current value.

4. The power supply unit of claim 2, wherein the power supply unit is equivalent to the virtual power source equivalent model, and
wherein the virtual power source equivalent model comprises:
a DC Thévenin equivalent model comprising an equivalent voltage source and the virtual impedance in series connection with the equivalent voltage source; and
a DC current source in parallel connection with the DC Thévenin equivalent model,
wherein the equivalent voltage source has the reference voltage value, and the DC current source has the reference current value.

5. The power supply unit of claim 2, wherein the regulation control circuit further comprises:
a reference setting circuit coupled to the controller, and configured to set the reference voltage value and the reference current value.

6. The power supply unit of claim 2, wherein the regulation control circuit further comprises:
an impedance setting circuit coupled to the controller, and configured to set a resistance value and an inductance value of the virtual impedance.

7. The power supply unit of claim 1, wherein the DC power supply circuit comprises:
a DC power source configured to output a power supply signal;
a DC to DC converter configured to convert the power supply signal received from the DC power source to a converted power supply signal; and
an output network comprising the output port, and configured to output the output voltage and the output current at the output port based on the converted power supply signal.

8. A power supply network, comprising:
a first power supply unit, comprising:
a first direct current (DC) power supply circuit comprising a first output port, and configured to provide an output voltage and a first output current at the first output port; and
a first regulation control circuit coupled to the first DC power supply circuit, and configured to generate a first regulation control signal based at least in part on a first measured voltage value of the output voltage and a first measured current value of the first output current at the first output port,
wherein the first DC power supply circuit is further configured to regulate, based on the first regulation control signal, at least one of the output voltage to have a target voltage value or the first output current to have a first target current value at the first output port; and
a second power supply unit in parallel connection with the first power supply unit, and comprising:
a second DC power supply circuit comprising a second output port in parallel connection with the first output port, and configured to provide the output voltage and a second output current at the second output port; and
a second regulation control circuit coupled to the second DC power supply circuit, and configured to generate a second regulation control signal based at least in part on a second measured voltage value of the output voltage and a second measured current value of the second output current at the second output port,
wherein the second DC power supply circuit is further configured to regulate, based on the second regulation control signal, at least one of the output voltage to have the target voltage value or the second output current to have a second target current value at the second output port.

9. The power supply network of claim 8, wherein the first regulation control circuit comprises:
a first controller coupled to the first DC power supply circuit, and configured to:
determine a first difference signal based on a first virtual impedance of a first virtual power source equivalent model, a first voltage difference between the first measured voltage value of the output voltage and a reference voltage value, and a first current difference between the first measured current value of the first output current and a first reference current value; and
generate a first modulation reference signal based on the first difference signal; and
a first modulator coupled to the first controller and the first DC power supply circuit, and configured to generate the first regulation control signal based on the first modulation reference signal.

10. The power supply network of claim 9, wherein the first difference signal is expressed as follows:
$$d ( s ) = \frac{\vert {Z}_{v} \vert}{( \vert {Z}_{v} \vert + 1 )} \frac{( {V}_{s} - {V}_{o}^{′} )}{( {R}_{v} + {sL}_{v} )} + \frac{\vert {Z}_{v} \vert}{( \vert {Z}_{v} \vert + 1 )} ( {I}_{s} - {I}_{o}^{′} ) ,$$
wherein d(s) represents the first difference signal, Zᵥ represents the first virtual impedance comprising a resistance Rᵥ and an inductance Lᵥ, Vₛ represents the reference voltage value,
$${V}_{o}^{′}$$
represents the first measured voltage value of the output voltage, Iₛ represents the first reference current value, and Iₒ′ represents the first measured current value of the first output current.

11. The power supply network of claim 9, wherein the second regulation control circuit comprises:
a second controller coupled to the second DC power supply circuit, and configured to:
determine a second difference signal based on a second virtual impedance of a second virtual power source equivalent model, a second voltage difference between the second measured voltage value of the output voltage and the reference voltage value, and a second current difference between the second measured current value of the second output current and a second reference current value; and
generate a second modulation reference signal based on the second difference signal; and
a second modulator coupled to the second controller and the second DC power supply circuit, and configured to generate the second regulation control signal based on the second modulation reference signal.

12. The power supply network of claim 11, wherein the first target current value of the first power supply unit is equal to the second target current value of the second power supply unit.

13. The power supply network of claim 12, wherein the first power supply unit is equivalent to the first virtual power source equivalent model,
wherein the second power supply unit is equivalent to the second virtual power source equivalent model which is identical to the first virtual power source equivalent model,
wherein the first virtual impedance is identical to the second virtual impedance, and
wherein each of the first and second virtual power source equivalent models comprises:
a DC Thévenin equivalent model comprising an equivalent voltage source and the first or second virtual impedance in series connection with the equivalent voltage source; and
a DC current source in parallel connection with the DC Thévenin equivalent model,
wherein the equivalent voltage source has the reference voltage value, and the DC current source has the first or second reference current value.

14. The power supply network of claim 11, wherein the first target current value of the first power supply unit is equal to the second target current value of the second power supply unit multiplied by a proportional current sharing coefficient.

15. The power supply network of claim 14, wherein the proportional current sharing coefficient comprises a ratio between a first rated capacity of the first power supply unit and a second rated capacity of the second power supply unit.

16. The power supply network of claim 14, wherein the first power supply unit is equivalent to the first virtual power source equivalent model,
wherein the second power supply unit is equivalent to the second virtual power source equivalent model,
wherein the first virtual power source equivalent model comprises:
a first DC Thévenin equivalent model comprising a first equivalent voltage source and the first virtual impedance in series connection with the first equivalent voltage source; and
a first DC current source in parallel connection with the first DC Thévenin equivalent model;
wherein the second virtual power source equivalent model comprises:
a second DC Thévenin equivalent model comprising a second equivalent voltage source and the second virtual impedance in series connection with the second equivalent voltage source; and
a second DC current source in parallel connection with the second DC Thévenin equivalent model; and
wherein each of the first and second equivalent voltage sources has the reference voltage value, the first DC current source has the first reference current value, and the second DC current source has the second reference current value.

17. The power supply network of claim 14, wherein:
the first regulation control circuit further comprises:
a first reference setting circuit coupled to the first controller, and configured to set the reference voltage value and the first reference current value; and
a first impedance setting circuit coupled to the first controller, and configured to set a resistance value and an inductance value of the first virtual impedance; and the second regulation control circuit further comprises:
a second reference setting circuit coupled to the second controller, and configured to set the second reference current value based on the proportional current sharing coefficient and the first reference current value; and
a second impedance setting circuit coupled to the second controller, and configured to set a resistance value and an inductance value of the second virtual impedance based on the proportional current sharing coefficient and the first virtual impedance.

18. A method of operating a power supply unit comprising a direct current (DC) power supply circuit and a regulation control circuit, the method comprising:
providing, by the DC power supply circuit, an output voltage and an output current at an output port;
generating, by the regulation control circuit, a regulation control signal based at least in part on a measured voltage value of the output voltage and a measured current value of the output current at the output port; and
regulating, by the DC power supply circuit and based on the regulation control signal, at least one of the output voltage to have a target voltage value or the output current to have a target current value.

19. The method of claim 18, wherein generating the regulation control signal comprises:
determining a difference signal based on a virtual impedance of a virtual power source equivalent model, a voltage difference between the measured voltage value of the output voltage and a reference voltage value, and a current difference between the measured current value of the output current and a reference current value;
generating a modulation reference signal based on the difference signal; and
generating the regulation control signal based on the modulation reference signal.

20. The method of claim 19, wherein the power supply unit is equivalent to the virtual power source equivalent model, and
wherein the virtual power source equivalent model comprises:
a DC Thévenin equivalent model comprising an equivalent voltage source and the virtual impedance in series connection with the equivalent voltage source; and
a DC current source in parallel connection with the DC Thévenin equivalent model,
wherein the equivalent voltage source has the reference voltage value, and the DC current source has the reference current value.
